(19) United States
(12) Patent Application Publication
(10) Pub. No.: US 2026/0261317 A1
(43) Pub. Date: Sep. 3, 2026

(54) Asymmetric Physical Layer Secret Sharing Protocol

(71) Applicant: Rampart Communications, Inc., Linthicum Heights, MD (US)

(72) Inventor: Leopold P. Bertholet, Hanover, MD (US)

(21) Appl. No.: 19/066,762

(22) Filed: Feb. 28, 2025

(51) Int. Cl. H04B 7/06; H04B 7/0456

(52) U.S. Cl. CPC H04B 7/0639; H04B 7/0456

(57) ABSTRACT

Two communications devices generate a shared secret based on shared codebook matrices. One communication device has a single antenna and the other communication device has at least two antennas. A first communication device sends an initial message based on a unitary matrix. The second communication device responds with a message based on the first unitary matrix, a representation of the effective channel between the first communication device and the second communications device, and a codebook matrix. The first communications device processes the response message to determine the codebook matrix based on the unitary matrix.

### TECHNICAL FIELD

The present disclosure relates to wireless networking and communication, especially secure communications using the physical layer including a physical layer secret sharing protocol.

### BACKGROUND

At the physical layer of a wireless transmission, a wireless transmitter may encode multiple bits into a symbol by varying the magnitude/phase of the transmitted signal between predetermined values. For instance, the amplitude of two orthogonal signals may be manipulated to define multiple symbols according to their In-phase (I) and Quadrature (Q) components as I/Q points in a Quadrature Amplitude Modulation (QAM) encoding scheme. A constellation of a particular QAM encoding scheme defines the possible symbol values, and determines the number of bits conveyed per symbol. For example, a 16-QAM encoding scheme includes 16 predefined symbols at different I/Q points, with each symbol corresponding to a different set of four bits.

It is often desirable for wireless communication to be secure, that is, a third party is not able to determine the information communicated in the wireless communication. This is typically done using a cryptographic algorithm, method, or protocol that obscures the information that is wirelessly transmitted. The cryptographic algorithm uses a key or keys to protect the encrypted information. A key exchange is one of the first steps in establishing a secure wireless communications link. The two parties share a secret that allows them to encrypt and decrypt data while excluding an eavesdropper. Conventional key exchange algorithms provide a solution to the shared secret problem, but at a high cost.

### BRIEF DESCRIPTION OF THE DRAWINGS

FIG. 1 is a block diagram illustrating an example of a network system configured to communicate information securely between computing devices.

FIG. 2 is a block diagram illustrating an example of a Physical Layer Secret Sharing Protocol (PLSSP) exchange between two computing devices.

FIG. 3 is a flowchart illustrating an example of the steps carried out by a first computing device, such as Alice in an original PLSSP exchange.

FIG. 4 is a flowchart illustrating an example of the steps carried out by a first computing device, such as Bob in a unitarized PLSSP exchange.

FIG. 5 is a flowchart illustrating an example of the steps carried out by a first computing device, such as Alice in a unitarized PLSSP exchange.

FIG. 6 illustrates an example of how to assign angles to each combination of up to three bits in some versions of a unitarized PLSSP exchange.

FIG. 7 is a flowchart illustrating an example of the steps carried out by a first computing device, such as Bob in a SIMO PLSSP exchange.

FIG. 8 is a flowchart illustrating an example of the steps carried out by a first computing device, such as Alice in a SIMO PLSSP exchange.

FIG. 9 is a flowchart illustrating an example of the steps carried out by a first computing device, such as Bob in a MISO PLSSP exchange.

FIG. 10 is a flowchart illustrating an example of the steps carried out by a first computing device, such as Alice in a MISO PLSSP exchange.

FIG. 11 is a hardware block diagram depicting a computing device that may perform functions associated with operations described herein in connection with the techniques depicted in FIGS. 1-10.

### DETAILED DESCRIPTION

### Overview

A system and method are provided for: receiving at a first processor of a first communication device, a first encoded matrix based upon a unitary matrix distorted by an effective communication channel; determining a unitary projection of the first encoded matrix; selecting a codebook matrix from a codebook of unitary matrices, the codebook matrix associated with a message for transmission; multiplying the conjugate of the unitary projection of the first encoded matrix by the codebook matrix to produce a second encoded matrix; and transmitting a signal representing the second encoded matrix to a second communication device.

A system and method are provided for: sending a first unitary matrix from a first communication device to a second communication device via a forward communication channel; receiving from the second communication device, at a first processor of the first communication device, a first encoded matrix distorted by a reverse communication channel, wherein the first encoded matrix is based upon the first unitary matrix distorted by the forward communication channel and a codebook matrix selected from a codebook of unitary matrices; determining a unitary projection of the first encoded matrix; multiplying a transpose of the first unitary matrix by the unitary projection of the first encoded matrix to produce a recovered matrix; and determining which codebook matrix from the codebook of unitary matrices corresponds to the recovered matrix.

A system and method are provided for: receiving a first encoded matrix via at least two antennas of a first communication device, wherein each row of the first encoded matrix corresponds to a first encoded vector transmitted from a single antenna of a second communication device and received by a corresponding antenna of the at least two antennas of the first communication device; determining a left singular matrix of the first encoded matrix and a right singular matrix of the first encoded matrix; selecting a codebook matrix, from a codebook of unitary matrices, for a message for transmission; multiplying the codebook matrix by a conjugate transpose of the right singular matrix of the first encoded matrix to produce an intermediate matrix; multiplying a complex conjugate of the left singular matrix of the first encoded matrix by the intermediate matrix to produce a second encoded matrix; and transmitting a signal representing the second encoded matrix to the single antenna of the second communication device.

A system and method are provided for: sending a first encoded vector based on a first unitary matrix from a single antenna of a first communication device to at least two antennas of a second communication device; receiving, via the single antenna of the first communication device, a second encoded vector transmitted from the at least two antennas of the second communication device, wherein the second encoded vector is based upon the first unitary matrix, a codebook matrix selected from a codebook of unitary matrices, and a representation of an effective channel; expanding the second encoded vector into a second encoded matrix; determining a left singular matrix of the second encoded matrix and a right singular matrix of the second encoded matrix; multiplying a conjugate transpose of the first unitary matrix by a complex conjugate of the left singular matrix of the second encoded matrix to produce an intermediate matrix; multiplying a conjugate transpose of the right singular matrix of the second encoded matrix by the intermediate matrix to produce a recovered matrix; and determining which codebook matrix from the codebook of unitary matrices corresponds to the recovered matrix.

A system and method are provided for: receiving a first encoded vector via a single antenna of a first communication device, wherein the first encoded vector is based upon a unitary matrix transmitted by at least two antennas of a second communication device and distorted by an effective channel; expanding the first encoded vector into a first encoded matrix; determining a left singular matrix of the first encoded matrix and a right singular matrix of the first encoded matrix; selecting, via the first processor, a codebook matrix, from a codebook of unitary matrices, for a message for transmission; multiplying the codebook matrix by a conjugate transpose of the right singular matrix of the first encoded matrix to produce an intermediate matrix; multiplying a complex conjugate of the left singular matrix of the first encoded matrix by the intermediate matrix to produce a second encoded matrix; and transmitting a signal representing the second encoded matrix to at least two antennas of a second communication device.

A system and method are provided for: sending a first encoded matrix via at least two antennas of a first communication device to a single antenna of a second communication device, the first encoded matrix based on a first unitary matrix; receiving a second encoded matrix via the at least two antennas of the first communication device, wherein each row of the second encoded matrix corresponds to an encoded vector transmitted from the single antenna of the second communication device and received by a corresponding antenna of the at least two antennas of the first communication device, wherein the encoded vector is based upon the first unitary matrix distorted by an effective channel and a codebook matrix selected from a codebook of unitary matrices; determining a left singular matrix of the second encoded matrix and a right singular matrix of the second encoded matrix; multiplying a conjugate transpose of the first unitary matrix by a complex conjugate of the left singular matrix of the second encoded matrix to produce an intermediate matrix; multiplying a conjugate transpose of the right singular matrix of the second encoded matrix by the intermediate matrix to produce a recovered matrix; and determining which codebook matrix from the codebook of unitary matrices corresponds to the recovered matrix.

A system and method are provided for: sending a first unitary matrix from a first communication device to a second communication device over a forward wireless channel; receiving, via a reverse wireless channel, a first encoded matrix from the second communication device, wherein the first encoded matrix is based upon the first unitary matrix distorted by the forward wireless channel and a codebook matrix selected from a codebook of unitary matrices; determining a left singular matrix of the first encoded matrix and a right singular matrix of the first encoded matrix; multiplying a conjugate transpose of the first unitary matrix by a complex conjugate of the left singular matrix of the first encoded matrix to produce an intermediate matrix; multiplying a conjugate transpose of the right singular matrix of the first encoded matrix by the intermediate matrix to produce a recovered matrix; calculating at least one metric using elements of the recovered matrix; and selecting a codebook matrix from the codebook of unitary matrices based upon the at least one metric to determine which codebook matrix from the codebook of unitary matrices corresponds to the recovered matrix.

### DESCRIPTION OF EMBODIMENTS

A key exchange is one of the first steps in establishing a secure wireless communications link between devices. The two devices (say Alice and Bob) share a secret that allows them to encrypt and decrypt data while excluding an eavesdropping device (Eve). Conventional key exchange algorithms provide a solution to the shared secret problem, but at a high cost. Consider the Diffie-Hellman protocol, a common key exchange algorithm.

In a Diffie-Hellman exchange between Alice and Bob, Alice starts by selecting a random integer a, and computes x=g^{a} mod p, where g and p are prespecified constants. Note that Alice has to perform modular exponentiation involving large integers. Alice sends the integer x to Bob, which requires that Alice and Bob have already established a communications setup involving error correction and modulation.

Bob receives Alice's transmission, which Bob successfully demodulates and decodes to recover x. Bob also picks a random integer b, computes y=g^{b} mod p (so he also has to perform modular exponentiation), and transmits y to Alice (again with modulation and error correction).

Alice recovers y from Bob's transmission. Then, she and Bob obtain the key k by respectively computing y^{a} mod p and x^{b} mod p. As a result, Alice and Bob perform more modular exponentiation.

Therefore, before Alice and Bob can establish any shared secret at all, Alice and Bob must successfully set up a modulation scheme, an encoding convention, and error correction. Moreover, they need to perform nontrivial number theoretic computations that cost time and processing resources.

A new physical layer secret sharing protocol (PLSSP) will be disclosed herein. A PLSSP may include the following steps. In some examples, Alice generates four random complex numbers, which are grouped into a two-by-two matrix G, and Alice sends G over a subcarrier out of two antennas, over two timesteps. This approach assumes that a multiple-input multiple-output (MIMO) system is used to implement the PLSSP. Alice may be doing this on several subcarriers at once, for example, as in the case of orthogonal frequency division multiplexing (OFDM). Bob receives Alice's transmission, now distorted by the environment. This distortion may include frequency and phase distortions, multipath, etc. Bob selects a message C from a shared and known codebook of different messages that represents one or more bits. These one or more bits may become part of a shared secret between Alice and Bob. These messages C may be, for example, matrices and in this specific example two-by-two matrices. Bob performs two-by-two matrix operations on this received G and his selected message C to obtain a response R. Bob sends R to Alice out of two antennas, over two timesteps. Alice receives R from Bob, again affected by the environment, which reverses some of the original distortion based on the assumption that the reverse channel characteristics are a transpose of the forward channel. Alice applies matrix operations to this received data and G to recover Ĉ. Ĉ encodes a set of secret bit(s) and is part of the shared secret exchanged between Alice and Bob. This process may then be repeated a predetermined number of times and/or across a predetermined number of subcarriers to generate as many bits as needed to share a desired number of bits to allow for secret communication between Alice and Bob.

Also, Bob can initiate the PLSSP so that Alice generates secret bits to be part of the shared secret. This means that, for example, when a multicarrier system such as OFDM is used, specific carriers may be designated to allow Bob to generate and share secret bits with Alice, and other carriers may be designated to allow Alice to generate and share secret bits with Bob. Further, multiple carriers may be used in each direction to allow for multiple instances of the PLSSP to generate secret bits in parallel. Note that the environment itself, rather than Alice and Bob, has done all the work of distorting and then undistorting the transmissions.

It can be seen that PLSSP derives its security from an entirely different approach than Diffie-Hellman. Instead of relying on a computationally hard problem, PLSSP recognizes that Alice and Bob already share a sort of secret—the physical channel between them—to which an eavesdropper will not have access. This strategy makes use of the inherent randomness in the environment around Alice and Bob, taking advantage of the physical layer rather than viewing it as an impediment to communication. The key exchange is thereby accomplished with minimal work on the part of Alice and Bob: they perform constant-time operations on, for example, two-by-two matrices, and not number-theoretic computations. This approach also allows PLSSP to circumvent the need for modulation and error correction, while algorithms like Diffie-Hellman require a method for reliable bit exchange to be set up before the key is shared.

Throughout this disclosure Alice and Bob are identified as parties that are trying to establish a secure communication link. Eve is described as a third party trying to eavesdrop and intercept the communication between Alice and Bob. While Alice, Bob, and Eve may represent individuals or organizations, the actual steps associated with Alice, Bob, and Eve described herein are carried out using communication systems and equipment that may include, for example, transmitters, receivers, radios, antennas, processors, memory, data storage, network interfaces, busses, software, etc. This communication equipment is needed to carry out the needed calculations to perform the PLSSP, and the PLSSP is based upon the idea that the wireless communication channels between the communication equipment of the parties experience unique channel characteristics that are utilized to carry out a secret sharing protocol in a way that makes it difficult for Eve to obtain the secret shared information. Therefore, the PLSSP embodiments disclosed herein are carried out by communications systems and equipment that interact with the physical environment.

An additional advantage to using PLSSP is that its security is based on true randomness in the environment. It is impossible for an attacker without access to the channel to recover the shared key, regardless of their access to computational resources; this is known as information-theoretic security. In contrast, conventional key exchanges base their security on unproven hardness assumptions about certain computational problems. These assumptions live in the shadow of the possibility that clever new attacks, possibly involving quantum computers, might one day be discovered to degrade the security of a conventional key exchange.

Previous PLSSP embodiments for MIMO and single-input single-output (SISO) were previously described in various patents. Examples of such MIMO systems are described, for example, in U.S. Pat. No. 10,951,442 (the '442 patent), issued Mar. 16, 2021 and titled “Communication System and Method Using Unitary Braid Divisional Multiplexing (UBDM) with Physical Layer Security,” and examples of such SISO systems are described, for example, in U.S. Pat. No. 11,159,220, issued Oct. 26, 2021 and titled “Single Input Single Output (SISO) Physical Layer Key Exchange,” the entire contents of which are each incorporated by reference herein for all purposes.

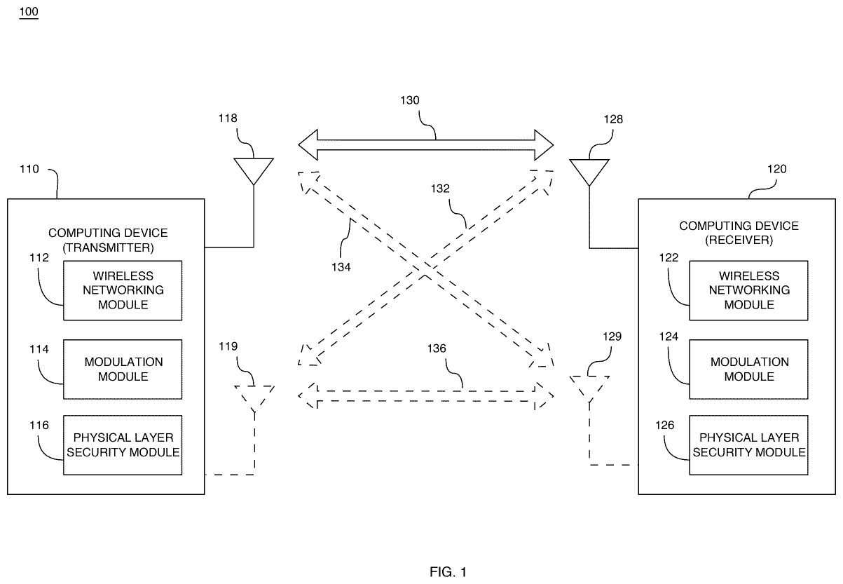

Referring now to FIG. 1, a simplified block diagram illustrates an example of a network system 100 configured to communicate information securely between computing devices. The network system 100 includes a computing device 110, which may also be referred to herein as a transmitter device. The computing device 110 includes a wireless networking module 112 that enables the computing device 110 to process communications signals and exchange information with other computing devices over a wireless network. The computing device 110 also includes a modulation module 114 that enables the computing device 110 to modulate and demodulate signals received from the wireless networking module 112. This modulation module 114 may use, for example, OFDM on encoded symbols from a constellation of predefined symbols. The computing device 110 includes a physical layer security module 116 that enables the computing device 110 to exchange secret information according to the PLSSP embodiments described herein. The computing device 110 may further include an antenna 118 that enables the computing device 110 to transmit/receive wireless signals to/from other computing devices. The computing device 110 may include one or more additional antennas 119, e.g., so that MIMO communication may be accomplished. A single additional antenna 119 is shown in FIG. 1 for simplicity, and the computing device 110 may include multiple additional antennas.

The network system 100 includes a computing device 120, which may also be referred to herein as a receiver device. The computing device 120 includes a wireless networking module 122 that enables the computing device 120 to process communications signals and exchange information with other computing devices over a wireless network. The computing device 120 also includes a modulation module 124 that enables the computing device 120 to modulate and demodulate signals received from the wireless networking module 122. This modulation and demodulation may use for example OFDM on encoded symbols from a constellation of predefined symbols. The computing device 120 includes a physical layer security module 126 that enables the computing device 120 to exchange secret information according to the PLSSP embodiments described herein. The computing device 120 may further include an antenna 128 that enables the computing device 120 to transmit/receive wireless signals to/from other computing devices. The computing device 120 may include one or more additional antennas 129, e.g., so that MIMO communication may be accomplished. A single additional antenna 129 is shown in FIG. 1 for simplicity, and the computing device 120 may include multiple additional antennas.

Communications between the computing device 110 and the computing device 120 may travel in wireless channels between the antennas of the computing devices 110 and 120. A wireless channel 130 connects the antenna 118 of the computing device 110 with the antenna 128 of the computing device 120. If the computing device 110 includes an additional antenna 119, then a wireless channel 132 connects the additional antenna 119 to the antenna 128 of the computing device 120. Similarly, if the computing device 120 includes an additional antenna 129, then a wireless channel 134 connects the antenna 118 of the computing device 110 to the additional antenna 129 of the computing device 120. Additionally, if the computing device 110 includes an additional antenna 119 and the computing device includes an additional antenna 129, then a wireless channel 136 connects the additional antenna 119 to the additional antenna 129. The wireless channels 130, 132, 134, and 136 may include different direct and multipath channels, and may be considered independently of each other.

In one example, the computing device 110 and/or computing device 120 may be embodied in a laptop computer, a desktop computer, a server, a network device, an Internet of Things (IoT) device, a mobile phone, a radio, any other wireless device, or an accessory device to any of the preceding devices. The computing devices 110 and 120 may be integrated into larger computing systems, such as a data center or cloud computing environment.

In another example, the wireless networking module 112 and the wireless networking module 122 may further include a software defined radio that enables the computing device 110 and the computing device 120, respectively, to adjust the parameters (e.g., frequency, amplitude, power, timing, etc.) of the wireless signals transmitted via the antennas 118/119 and the antennas 128/129.

In a further example, the computing device 110 and the computing device 120 may communicate via a computer network, such as a Local Area Network (LAN), a Wide Area Network (WAN), a private network, a Virtual Private Network (VPN), a Metropolitan Area Network (MAN), a Personal Area Network (PAN), a Wireless LAN (WLAN), a Wireless WAN (WWAN), a cellular network, and/or combinations thereof. The computer network between the computing device 110 and the computing device 120 may include segments over wired and/or wireless channels, such as Radio Frequency (RF) channels, Extremely Low Frequency (ELF) channels, Ultra Low Frequency (ULF) channels, Low Frequency (LF) channels, Medium Frequency (MF) channels, High Frequency (HF) channels, Very High Frequency (VHF) channels, Ultra High Frequency (UHF) channels, Extremely High Frequency (EHF) channels, and/or satellite channels. The computer network between the computing device 110 and the computing device 120 may also include one or more segments over optical networks (e.g., based on Synchronous Optical Networking (SONET), Synchronous Digital Hierarchy (SDH), or Optical Transport Network (OTN) protocols).

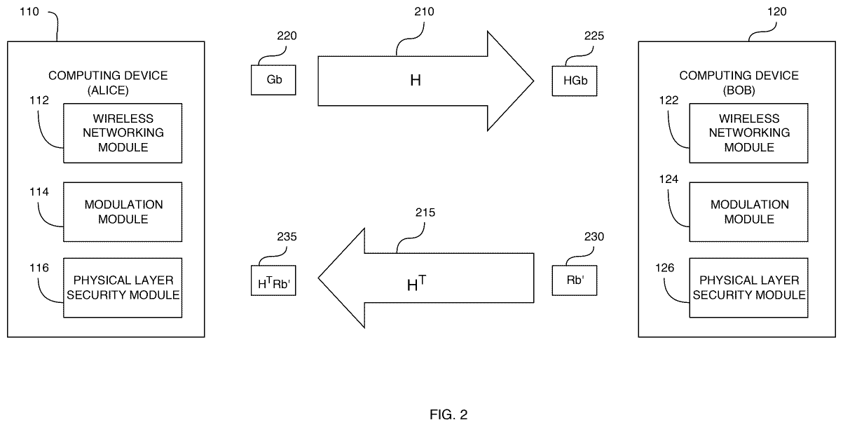

The general concept behind PLSSP is described above, but a more detailed description of the operations Alice and Bob can perform to exchange a key is now provided with respect to FIG. 2. One embodiment of PLSSP as described in the '442 patent, called original PLSSP throughout this disclosure, is used to illustrate the basic key exchange protocol through a forward wireless communication channel 210 and a reverse wireless communication channel 215.

The computing device 110 (Alice) starts by selecting a secret random unitary matrix G. Next, Alice sends a message 220 with an encoded matrix Gb where b is a known signal. A computing device 120 (Bob) receives a message 225 with a distorted matrix HGb where H is a matrix describing the characteristics of the forward channel 210 between Alice and Bob. Moreover, the characteristics of the reverse channel 215 are described by H^{T} or the transpose of the forward channel 210. Bob responds with a message 230 including a matrix Rb′, where R is constructed from the received message 225. After the message 230 passes through the reverse channel 215, Alice receives the message 235 with the encoded matrix H^{T} Rb′. The known signals b and b′ may be training sequences that may be the same or different. For simplicity, the known signals b and b′ may be omitted hereinafter, with the assumption that each computing device (e.g., Alice and Bob) removes the known signal before processing any received matrix.

A singular value decomposition (SVD) may be used to examine this process in greater detail. The SVD helps in the understanding of a MIMO OFDM system by providing a decomposition of the channel matrix into multiple parts. The SVD of the channel may be expressed as

$$H = B D {A}^{†} ,$$

where B and A are unitary matrices, and D is a real nonnegative diagonal matrix, not necessarily unitary. Note a dagger † is used to notate the conjugate transpose of a matrix. In this example, all three matrices in this decomposition are two-by-two matrices to correspond to a two-by-two MIMO system. If more antennas are used, then the matrices used will be sized correspondingly. Note there is a non-uniqueness to the SVD which manifests as a random diagonal phase matrix 8, but this will be ignored in this description to provide insights into the process.

In particular, the SVD reveals structure in the H matrix that Alice and Bob can take advantage of to exchange information. The diagonal component D acts as a “barrier” between the left and right singular vector unitary matrices B and A. In original PLSSP, the actual singular values in D are disregarded as D is viewed as a separator. A may be thought of as Alice's unitary matrix. When Alice sends a unitary matrix G encoded as Gb, Bob receives BDA^{†}Gb. After removing b, Bob uses the SVD to separate out each side of the barrier and recover B and A^{†}G individually. So, A^{†} acts on whatever Alice sends. Similarly, B can be thought of as Bob's unitary matrix. When Bob sends Rb, where R is a unitary matrix, Alice gets H^{T} Rb=A*DB^{T} Rb, from which she separates out A* and B^{T} R after removing b. So, B^{T} acts on whatever Bob sends.

In summary, each party knows their own unitary matrix. Bob learns B when Alice sends him something, and Alice learns A when Bob sends her something. Each party's matrix modifies what they send. When Alice sends G, Bob gets A^{†}G. When Bob responds with R, Alice receives B^{T} R.

With the above background, Bob may pick bits of a secret key as “key bits” and encode them in a unitary matrix C. Bob now sends C to Alice in such a way that only Alice may recover it. Alice starts the key exchange by picking a random unitary matrix G and transmitting it to Bob. Because only Alice knows G before it is distorted by the channel, only Alice will be able to reverse it later on. As shown above, Bob receives A^{†}G. Bob also knows his B, and he knows the C he wants to send. The channel from Bob to Alice undistorts the effect of the channel from Alice to Bob when Bob sends R to Alice. This cancellation of the effects of the channel is only experienced by Alice due to her physical location. An eavesdropper standing somewhere else will not have the same channel. To remove the distortion caused by the channel H between Alice and Bob, Bob cancels out the effect by use of the reverse channel H^{T}. Because Bob has access to B, he can do this by starting R with B*, because B is unitary and therefore satisfies B^{T} B*=I. Then, Bob can include C, the actual message he needs to send to Alice. Finally, Bob needs to protect the message by incorporating G, which only Alice knows. Bob can do this by multiplying in A^{†}G, which he received from Alice. So, a very natural choice for Bob's response is

$$R = ( {B}^{*} ) ( C ) ( {A}^{†} G ) .$$

In summary, Bob uses B* to make sure the reverse channel will undistort the forward channel. Next, Bob includes his key bits encoded in a matrix C. Then Bob protects his transmission by including what he received from Alice, A^{†}G.

Now it can be determined that Alice can recover C. Based on the description above, Alice will recover:

$${B}^{T} R = {B}^{T} {B}^{*} C {A}^{†} G = C {A}^{†} G .$$

Alice knows her unitary matrix A, and she knows G (as she generated it), so Alice can remove them from CA^{†}G to isolate C. Therefore, Alice and Bob will both know C, but because of G and H, an adversary should not. The steps above can be formulated in terms of the SVD components on each side to yield a concrete algorithm.

As a final note, if the d terms are added back into the equations to account for the SVD's non-uniqueness, additional ambiguity is introduced. Alice ends up receiving ACA instead of C, where A is a random diagonal phase matrix Alice does not know. However, Bob can account for this by picking a codebook (a set of matrices for the possible key bits) that is robust against this ambiguity, making sure that any matrices Bob might send cannot be confused with each other under the phase modification. Examples of such matrices are described below.

An example of the steps in the algorithm specifically described in the '442 patent or original PLSSP are now described.

Step 1: Alice generates a two-by-two complex unitary matrix G that she keeps private. The unitary matrix G may be newly generated for each PLSSP exchange. Alternatively, the unitary matrix G may be randomly selected from a plurality of pre-generated unitary matrices. Alice may refresh the plurality of pre-generated unitary matrices periodically to maintain at least one unitary matrix that has not previously been selected for a PLSSP exchange.

Step 2: Alice sends G to Bob over complex channel H as an encoded matrix Gb where b is known. The b signal may be a predetermined training sequence, which is modified by Alice with the unitary matrix G. The complex channel H further modifies the encoded matrix Gb based on the radio frequency environment between Alice and Bob.

Step 3: Bob receives HGb. Bob removes the predetermined signal b and performs an SVD on the remaining signal HG: HG↔(U_{b}, D_{b}, V_{b}) where U_{b} is a left singular matrix, V_{b} is a right singular matrix, and D_{b} is a real nonnegative diagonal matrix of the SVD.

When the complex channel H is expressed in terms of its individual components H=BDA^{†}, the SVD can be rewritten as

$$\begin{matrix}HG = {BDA}^{†} G \\ = B {D ( {G}^{†} A )}^{†} ↔ ( B {δ}_{1} , D , {G}^{†} A {δ}_{1} ) ,\end{matrix}$$

where multiplier δ₁ is a random diagonal unitary matrix accounted for during the SVD process:

$${δ}_{1} = ( \begin{matrix}{e}^{i {θ}_{1}} & 0 \\ 0 & {e}^{i {θ}_{2}}\end{matrix} ) ,$$

with θᵢ∈[0,2π).

Step 4: Bob encrypts his message C as

$$R = {U}_{b}^{*} C {V}_{b}^{†} b$$

and send it to Alice over the reverse channel H^{T} where b is known and where b may be the same as in step 2 above or different. The signal b may be a predetermined training sequence. R could be rewritten as

$$R = {B}^{*} {δ}_{1}^{*} C {δ}_{1}^{*} {A}^{†} Gb$$

in terms of the individual components of the complex channel H.

Step 5: Alice receives H^{T} Rb. Alice removes the predetermined signal b and performs an SVD on it: H^{T} R↔(Uₐ, Dₐ, Vₐ).
H^{T} R could be rewritten as

$${H}^{T} {B}^{*} {δ}_{1}^{*} C {δ}_{1}^{†} {A}^{†} G$$

Alice's SVD would then be

$$\begin{matrix}{H}^{T} {B}^{*} {δ}_{1}^{*} C {δ}_{1}^{†} {A}^{†} G = {( {BDA}^{†} )}^{T} ( {B}^{*} {δ}_{1}^{*} C {δ}_{1}^{†} {A}^{†} G ) \\ = ( {A}^{*} D {B}^{T} ) ( {B}^{*} {δ}_{1}^{*} C {δ}_{1}^{†} {A}^{†} G ) \\ = {A}^{*} D {δ}_{1}^{*} C {δ}_{1}^{†} {A}^{†} G \\ = ( {A}^{*} ) ( D ) {( {G}^{†} A {δ}_{1} {C}^{†} {δ}_{1}^{T} )}^{†} ↔ ( {A}^{*} {δ}_{2} , D , {G}^{†} A {δ}_{1} {C}^{†} {δ}_{1}^{T} {δ}_{2} )\end{matrix}$$

Step 6: Alice calculates the phase-shifted C through

$$\hat{C} = {V}_{a}^{†} {G}^{†} {U}_{a}^{*} .$$

The approximated Ĉ is a phase-shifted value ΔCΔ. Alice knows G from her original matrix generation, so Alice can remove it by multiplying

$$G ( {V}_{a} ) = G ( {G}^{†} A {δ}_{1} {C}^{†} {δ}_{1}^{T} {δ}_{2} ) = A {δ}_{1} {C}^{†} {δ}_{1}^{T} {δ}_{2} .$$

Alice also knows A*δ₂ from Uₐ of the SVD, so Alice can remove A*δ₂ by multiplying by the transpose as follows:

$${( {U}_{a} )}^{T} ( A {δ}_{1} {C}^{†} {δ}_{1}^{T} {δ}_{2} ) = {( {A}^{*} {δ}_{2} )}^{T} ( A {δ}_{1} {C}^{†} {δ}_{1}^{T} {δ}_{2} ) = {δ}_{2}^{T} {δ}_{1} {C}^{†} {δ}_{1}^{T} {δ}_{2} .$$

Notice that because the δ matrices are diagonal unitary matrices, the matrices commute and are their own transpose. After rearranging and taking the conjugate transpose, Alice obtains

$${δ}_{2}^{*} {δ}_{1}^{*} C {δ}_{1}^{*} {δ}_{2}^{*} = Δ C Δ = \hat{C} , where Δ = {δ}_{1}^{*} {δ}_{2}^{*}$$

is a diagonal phase matrix.

Step 7: Alice recovers the original C through an appropriate recovery function.

As mentioned above, Bob will encode his message in a “codebook matrix”. That is, Alice and Bob have decided upon a convention for mapping a bit message to a unique two-by-two matrix. The set of codebook matrices for all possible bit messages of a certain length may be called a codebook. Each codebook will have a unique way of mapping the matrices back to their equivalent bits. The method of mapping a noisy received codebook matrix to a bit message is the recovery algorithm. A few different examples of one-bit, two-bit, and three-bit codebooks for original PLSSP will now be described along with their decision metrics.

First, three different one-bit codebooks will be described.

In a first version of a one-bit codebook, a codebook matrix corresponding to key bits kb may be represented by C_{kb}.

$${C}_{( 0 )} = ( \begin{matrix}1 & 0 \\ 0 & 1\end{matrix} ) , \qquad {C}_{( 1 )} = ( \begin{matrix}0 & 1 \\ 1 & 0\end{matrix} ) .$$

The recovery algorithm for this codebook includes computing the value

$$s = \vert {\hat{c}}_{11} \vert - \vert {\hat{c}}_{12} \vert .$$

If s≥0, C₍₀₎ is recovered. If s<0, C₍₁₎ is recovered. This is summarized in Table 1 below.

TABLE 1

| Sign of s | Recovered Bit |
|---|---|
| s ≥ 0 | (0) |
| s < 0 | (1) |

In a second version of a one-bit codebook, a codebook matrix corresponding to key bits kb may be represented by C_{kb}.

$${C}_{( 0 )} = ( \begin{matrix}0 & 1 \\ - 1 & 0\end{matrix} ) , \qquad {C}_{( 1 )} = ( \begin{matrix}0 & i \\ i & 0\end{matrix} ) .$$

The recovery algorithm for this codebook includes computing the value

$$s = R e ( {\hat{c}}_{12} \cdot {\hat{c}}_{21}^{*} ) .$$

If s≥0, C₍₀₎ is recovered. If s<0, C₍₁₎ is recovered. This is summarized in Table 1 above.

In a third version of a one-bit codebook, a codebook matrix corresponding to key bits kb may be represented by C_{kb}.

$${C}_{( 0 )} = ( \begin{matrix}1 & 0 \\ 0 & 1\end{matrix} ) , \qquad {C}_{( 1 )} = ( \begin{matrix}0 & - 1 \\ 1 & 0\end{matrix} ) .$$

The recovery algorithm for this codebook includes computing the value

$$s = \vert {\hat{c}}_{11} \vert - \vert {\hat{c}}_{12} \vert .$$

If s≥0, C₍₀₎ is recovered. If s<0, C₍₁₎ is recovered. This is summarized in Table 1 above.

Next a two-bit codebook will be described. The following four codebook matrices C_{kb} may be defined.

$$\begin{matrix}{C}_{( 0 , 0 )} = ( \begin{matrix}1 & 0 \\ 0 & 1\end{matrix} ) , & {C}_{( 0 , 1 )} = ( \begin{matrix}0 & 1 \\ - 1 & 0\end{matrix} ) , \\ {C}_{( 1 , 0 )} = ( \begin{matrix}0 & {e}^{i π / 3} \\ − {e}^{− i π / 3} & 0\end{matrix} ) , & {C}_{( 1 , 1 )} = ( \begin{matrix}0 & {e}^{- i π / 3} \\ − {e}^{− i π / 3} & 0\end{matrix} ) .\end{matrix}$$

Given a received matrix Ĉ, the value s₁ in radians is computed as

$${s}_{1} = arg ( \vert {\hat{c}}_{11} \vert + \vert {\hat{c}}_{12} \vert i )$$

and then it is compared to either 0 or π/2. If s₁ is closest to 0, then C_{(0,0)} is recovered. If s₁ is closest to π/2, then more information is needed and a second metric is calculated as

$${s}_{2} = arg ( - \frac{{\hat{c}}_{12}}{{\hat{c}}_{21}} ) .$$

If s₂ is closest to 0, then C_{(0,1)} is recovered. If s₂ is closest to 2π/3, then C_{(1,0)} is recovered. If s₂ is closest to −2π/3, then C_{(1,1)} is recovered. This is summarized in Table 2 below.

TABLE 2

| s₁ Closest to | s₂ Closest to | Recovered Bits |
|---|---|---|
| 0 | N/A | (0, 0) |
| π/2 | 0 | (0, 1) |
| | 2π/3 | (1, 0) |
| | −2π/3 | (1, 1) |

It is important to note whether the arg function used returns values between 0 and 2π or values between −π and π (which is the assumption above); it does not matter as long as there is a consistent convention.

Next a three-bit codebook will be described. The following eight codebook matrices C_{kb} may be defined.

$$\begin{matrix}{C}_{( 0 , 0 , 0 )} = ( \begin{matrix}1 & 0 \\ 0 & 1\end{matrix} ) , & {C}_{( 0 , 0 , 1 )} = ( \begin{matrix}\frac{1}{\sqrt{2}} & \frac{1}{\sqrt{2}} \\ − \frac{1}{\sqrt{2}} & \frac{1}{\sqrt{2}}\end{matrix} ) , \\ {C}_{( 0 , 1 , 0 )} = ( \begin{matrix}0 & 1 \\ − 1 & 0\end{matrix} ) , & {C}_{( 0 , 1 , 1 )} = ( \begin{matrix}0 & {e}^{i π / 6} \\ − {e}^{− i π / 6} & 0\end{matrix} ) , \\ {C}_{( 1 , 0 , 0 )} = ( \begin{matrix}0 & {e}^{i π / 3} \\ − {e}^{− i π / 3} & 0\end{matrix} ) , & {C}_{( 1 , 0 , 1 )} = ( \begin{matrix}0 & 1 \\ 1 & 0\end{matrix} ) , \\ {C}_{( 1 , 1 , 0 )} = ( \begin{matrix}0 & {e}^{2 i π / 3} \\ − {e}^{− 2 i π / 3} & 0\end{matrix} ) , & {C}_{( 1 , 1 , 1 )} = ( \begin{matrix}0 & {e}^{5 i π / 6} \\ − {e}^{− 5 i π / 6} & 0\end{matrix} ) .\end{matrix}$$

Given a received matrix Ĉ, a value in radians is computed as

$${s}_{1} = arg ( \vert {\hat{c}}_{11} \vert + \vert {\hat{c}}_{12} \vert i ) .$$

Then s₁ is compared to either 0, π/4, or π/2. If s₁ is closest to 0, then C_{(0,0,0)} is recovered. If s₁ is closest to π/4, then C_{(0,0,1)} is recovered. If s₁ is closest to π/2, then more information is needed and a second metric is calculated as

$${s}_{2} = arg ( - \frac{{\hat{c}}_{12}}{{\hat{c}}_{21}} )$$

and recovery of a codebook matrix is based on the closest multiple of π/3 to this angle. The recovery algorithm is detailed in Table 3 below.

TABLE 3

| s₁ Closest to | s₂ Closest to | Recovered Bits |
|---|---|---|
| 0 | N/A | (0, 0, 0) |
| π/4 | N/A | (0, 0, 1) |
| π/2 | −2π/3 | (1, 1, 0) |
| | −π/3 | (1, 1, 1) |
| | 0 | (0, 1, 0) |
| | π/3 | (0, 1, 1) |
| | 2π/3 | (1, 0, 0) |
| | π | (1, 0, 1) |

As shown, if −π/6<s₂<π/6, then C_{(0,1,0)} is recovered. If π/6<s₂<π/2, then C_{(0,1,1)} is recovered. If π/2<s₂<5π/6, then C_{(1,0,0)} is recovered. If 5π/6<s₂ or s₂<−5π/6, then C_{(1,0,1)} is recovered. If −5π/6<s₂<−π/2, then C_{(1,1,0)} is recovered. And if −π/2<s₂<−π/6, then C_{(1,1,1)} is recovered. Again, this recovery algorithm is based on maintaining a consistent convention for the arg function.

Various specific examples of codebooks and recovery metrics have been described above for original PLSSP. Other codebooks and recovery methods may be used for original PLSSP as well that satisfy the requirement that the recovered codebook entries are able to be accurately associated with an associated entry in the codebook to accurately determine the bits sent.

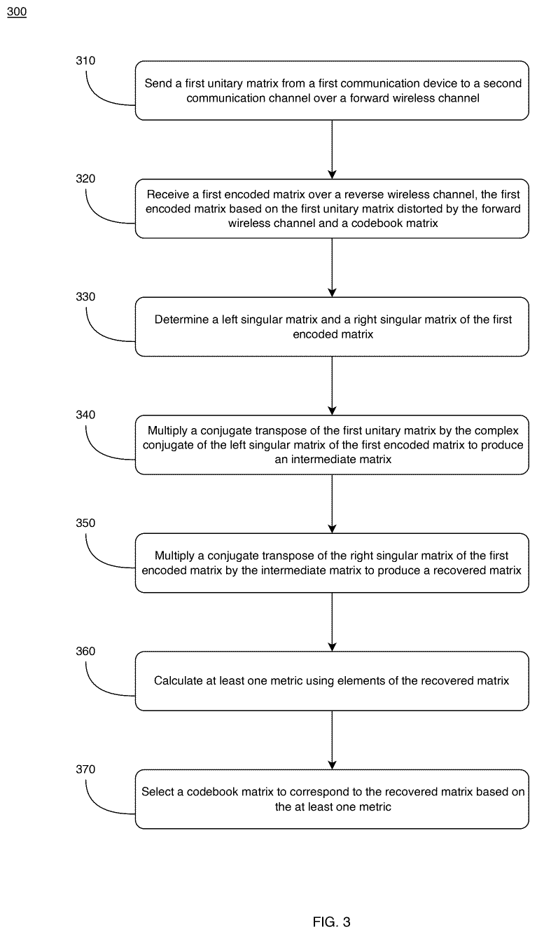

FIG. 3 is a flowchart illustrating an example process 300 performed by a processor in a first computing device, such as Alice in the original PLSSP key exchange. At step 310, the first computing device sends a first unitary matrix to a second communication device over a forward wireless channel. In some examples, the first unitary matrix is randomly generated and kept secret. At step 320, the first communication device receives, via a reverse wireless channel, a first encoded matrix from the second communication device. The first encoded matrix is based upon the first unitary matrix distorted by the forward wireless channel and a codebook matrix selected (e.g., by the second communication device) from a codebook of unitary matrices. In some examples, the codebook of unitary matrices is publicly known. Each codebook matrix in the codebook of unitary matrices is associated with an index number that the first communication device and the second communication device may use to determine at least a portion of a shared key.

At step 330, the first communication device determines a left singular matrix of the first encoded matrix and a right singular matrix of the first encoded matrix. In some examples, the first communication device performs an SVD on the first encoded matrix. At step 340, the first communication device multiplies a conjugate transpose of the first unitary matrix by a complex conjugate of the left singular matrix of the first encoded matrix to produce an intermediate matrix. Next, at step 350, the first communication device multiplies a conjugate transpose of the right singular matrix of the first encoded matrix by the intermediate matrix to produce a recovered matrix.

At step 360, the first communication device calculates at least one metric using elements of the recovered matrix. In some examples, the metric may be defined by fewer than all of the elements of the recovered matrix. At step 370, the first communication device selects a codebook matrix from the codebook of unitary matrices based upon the metric(s) to determine which codebook matrix from the codebook of unitary matrices corresponds to the recovered matrix. In some examples, metric(s) may be compared to a predetermined threshold(s)

$$( e . g . , 0 , \frac{π}{2} , \frac{π}{4} , \pm \frac{2}{3} π , etc . )$$

to determine which metric is closest to the predetermined threshold or to determine the sign of a metric.

A new unitarized PLSSP embodiment will now be described. An aspect of PLSSP is that the matrices sent by Alice and Bob are unitary. In PLSSP, only the channel matrix H is non-unitary. The set of two-by-two unitary matrices, denoted by [symbol] (2), forms a matrix group and provides a convenient setting in which to perform encryption and decryption operations. Unitarized PLSSP enables the structure of [symbol] (2) to be exploited by making the channel H unitary as well.

The tool used by unitarized PLSSP is a unitarization operation. This unitarization operation takes in a square matrix M and outputs [symbol] , which is the projection of M onto the space of unitary matrices. [symbol] may be thought of as the closest unitary matrix to M; it can be computed from the SVD of M. Two properties of unitarization include:
1. Unitarization commutes with multiplication by a unitary matrix. That is, for a unitary matrix X,

$${( M X )}^{𝒰} = {M}^{𝒰} X .$$

2. Unitarization commutes with matrix transposition. That is,

$${( {M}^{T} )}^{𝒰} = {( {M}^{𝒰} )}^{T} .$$

If Alice and Bob both agree to apply this projection operation to every message they receive, they can effectively unitarize the channel matrix H and replace it with Ĥ= [symbol] . Indeed, if Bob applies the unitary projection to HG, using property 1 he obtains

$$\begin{matrix}{( H G )}^{𝒰} = {H}^{𝒰} G \\ = \hat{H} G\end{matrix}$$

Similarly, if Alice applies the unitary projection to H^{T} R, using properties 1 and 2 she obtains

$$\begin{matrix}{( {H}^{T} R )}^{𝒰} = {( {H}^{T} )}^{𝒰} R \\ = {( {H}^{𝒰} )}^{T} R \\ = \hat{H} R\end{matrix} .$$

Effectively, the original PLSSP setup has been replaced with a unitarized setup by substituting Ĥ for H.

Now that the channel Ĥ is unitary, it becomes apparent how Bob can proceed to send Alice his unitary matrix C. As with original PLSSP, Bob needs the reverse channel Ĥ^{T} to reverse the effect of the forward channel Ĥ. For a unitary channel, this is simple: Bob can use the fact that Ĥ^{T} Ĥ*=I by conjugating what he received from Alice. Then, Bob multiplies this result by his message C. In other words, his response is just

$$R = ( \hat{H} G ) * C .$$

Alice will receive

$${\hat{H}}^{T} R = {\hat{H}}^{T} \hat{H} * G * C = G * C .$$

Alice knows G and can easily remove it from this expression to isolate C,

$${G}^{T} ( G * C ) = C .$$

This process leads to the unitarized PLSSP algorithm described below.

The explicit steps to unitarized PLSSP along with their respective mathematical reasoning are as follows. Again, say that Bob is sending a message to Alice. The algorithm for unitarized PLSSP is similar to the original one but modifies the order of multiplications performed by Bob and Alice. In the description of the original PLSSP Alice encodes the G matrix using a signal b for transmitting G to Bob. Likewise, Bob uses the same or a different b signal to encode his response for transmission to Alice. To simplify the description of the steps of the of the various embodiments of PLSSP algorithms described below, the use of the b signal will not be explicitly described, but is assumed to be part of the encoding, transmission, and decoding of Alice's G matrix and Bob's response.

Step 1: Alice generates a two-by-two complex unitary matrix G that she keeps private.

Step 2: Alice sends an encoded G to Bob over complex channel H.

Step 3: Bob receives HG. Bob performs an SVD on HG: HG↔(U_{b}, D_{b}, V_{b}).
When the complex channel H is expressed in terms of its individual components H=BDA^{†}, the SVD can be rewritten as

$$\begin{matrix}HG = {BDA}^{†} G \\ = {BD ( {G}^{†} A )}^{†} \\ ↔ ( B {δ}_{1} , D , {G}^{†} A {δ}_{1} )\end{matrix}$$

where multiplier δ is any random diagonal unitary matrix accounted for during the SVD process:

$$δ = ( \begin{matrix}{e}^{i {θ}_{1}} & 0 \\ 0 & {e}^{i {θ}_{2}}\end{matrix} )$$

with θᵢ∈[0,2π).

Step 4: Bob encrypts his message C as

$$R = {U}_{b}^{*} {V}_{b}^{T} C$$

and sends it to Alice back over the reverse channel H^{T}. This may be done because Bob is treating the channel as a unitarized channel.
R could be rewritten as

$$R = B * {δ}_{1}^{*} {δ}_{1}^{T} {A}^{T} G * C = B * {A}^{T} G * C$$

in terms of the individual components of the complex channel H. Note that this construction of R differs from the original PLSSP algorithm despite using the same components.

Step 5: Alice receives H^{T} R and performs an SVD on it: H^{T} R↔(Uₐ, Dₐ, Vₐ).
H^{T} R could be rewritten as

$${H}^{T} B * {δ}_{1}^{*} {δ}_{1}^{T} {A}^{T} G * C = {H}^{T} B * {A}^{T} G * C .$$

Alice's SVD would therefore be

$$\begin{matrix}{H}^{T} B * {δ}_{1}^{*} {δ}_{1}^{T} {A}^{T} G * C = {( {BDA}^{†} )}^{T} ( B * {A}^{T} G * C ) \\ = ( A * {DB}^{T} ) ( B * {A}^{T} G * C ) \\ = A * {DA}^{T} G * C \\ {= ( A \text{*)} ( D ) ( {C}^{†} {G}^{T} A \text{*)}}^{†} \\ ↔ ( A * {δ}_{2} , D , {C}^{†} {G}^{T} A * {δ}_{2} )\end{matrix}$$

continuing to account for multiplier δ.

Step 6: Alice calculates the original C through the formula

$$\hat{C} = {G}^{T} {U}_{a} {V}_{a}^{†} .$$

This computation returns the original C as described through the following definition of H as before:

$$\begin{matrix}{G}^{T} {U}_{a} {V}_{a}^{†} = {G}^{T} A * {{δ}_{2} ( {C}^{†} {G}^{T} A * {δ}_{2} )}^{†} \\ = {G}^{T} A * {δ}_{2} {δ}_{2}^{†} {A}^{†} G * C \\ = C\end{matrix}$$

as desired. Note, Alice no longer needs to account for multiplier Δ in her recovered codebook matrix Ĉ as she did in the original PLSSP algorithm.

Step 7: The addition of additive white Gaussian noise (AWGN) alters the recovered Ĉ values slightly, therefore some distance function must be used to calculate which codebook is “closest” to the recovered Ĉ.

Embodiments of recovery metrics and potential codebooks for unitarized PLSSP will now be described.

In unitarized PLSSP, unlike in original PLSSP, Alice recovers C exactly, without any leftover distortion from an unknown phase. The phase terms cancel out in the various calculations to produce R by Bob and to recover C by Alice. This means that the codespace (the space of possible messages Bob can send) is now larger than for original PLSSP, which improves the error performance of the key exchange because the codebook matrices can be spread out in this larger codespace. Well-performing codebooks were found within this space using a few different methods. A few codebooks and their recovery algorithms are described in the next few sections.

The distance metrics used in unitarized PLSSP (including Frobenius distance or diversity distance) calculate the distances between the recovered matrix Ĉ after decryption and each matrix in the specified codebook. Thereafter, the matrix in the codebook with the shortest distance d to the recovered matrix is chosen as the original message sent by Bob.

The Frobenius distance between matrices corresponds to the standard Euclidean distance if the matrices were vectors, i.e.,

$${d}_{F} ( X , Y ) = {‖ X - Y ‖}_{F} = \sqrt{{\sum }_{i = 1}^{n} {\sum }_{j = 1}^{m} {\vert {x}_{ij} - {y}_{ij} \vert}^{2} .} \qquad ( 1 )$$

Taking the square root to find the distance does not affect which codebook matrix is closest to the received one, so it may be more efficient to use the squared distance,

$${d}_{F}^{2} ( X , Y ) = {\sum }_{i = 1}^{n} {\sum }_{j = 1}^{m} {\vert {x}_{ij} - {y}_{ij} \vert}^{2} .$$

The diversity distance was developed as an optimal way of measuring distance between matrices in the field of Unitary Space-Time Codes (USTC), which also deals with codebooks on the space of unitary matrices. USTC codebook schemes may not be optimal for PLSSP, but they provide a good starting point for codebook development, and diversity distance performs well for PLSSP codebooks. Diversity distance is given by:

$${d}_{D} ( X , Y ) = {‖ X - Y ‖}_{D} = \vert det ( X - Y ) \vert .$$

For two-by-two matrices, this is just

$${d}_{D} ( X , Y ) = \vert ( {x}_{11} - {y}_{11} ) ( {x}_{22} - {y}_{22} ) - ( {x}_{12} - {y}_{12} ) ( {x}_{21} - {y}_{21} ) \vert .$$

Note that, strictly speaking, diversity is not an actual distance metric.

A few embodiments of codebooks will now be described.

One example of a unitarized PLSSP one-bit codebook is

$${C}_{( 0 )} = ( \begin{matrix}1 & 0 \\ 0 & 1\end{matrix} ) , \qquad {C}_{( 1 )} = ( \begin{matrix}- 1 & 0 \\ 0 & - 1\end{matrix} ) .$$

For this example of a one-bit codebook, the squared Frobenius distance (as described above) may be used.

This may actually be simplified to yield an easier recovery function. Note that the only difference between C₍₀₎ and C₍₁₎ is the real parts of the diagonal entries. Therefore, only these need to be considered when computing the squared distance to Ĉ. This modified squared distance is

$${( Re {\hat{c}}_{11} ∓ 1 )}^{2} + {( Re {\hat{c}}_{22} ∓ 1 )}^{2} = {( Re {\hat{c}}_{11} )}^{2} + {( Re {\hat{c}}_{22} )}^{2} + 2 ∓ 2 ( {\underbrace{Re {\hat{c}}_{11} + Re {\hat{c}}_{22}}}_{s} ) ,$$

where ± corresponds respectively to the C₍₀₎ and C₍₁₎ cases. But observe that in this expression, only the sign of the expression labeled s is important in determining which distance will be smaller. If s>0, then the distance to C₍₀₎ is smaller; if s<0, then the distance to C₍₁₎ is smaller.

Therefore, in the following recovery algorithm, after obtaining Ć, compute

$$s = Re {\hat{c}}_{11} + Re {\hat{c}}_{22} .$$

This metric calculation is the sum of the real portions of the elements along the main diagonal of Ĉ. If s≥0, C₍₀₎ is recovered. Otherwise, C₍₁₎ is recovered. Note that the case where s=0 is ambiguous and is selected to indicate C₍₀₎, but in other embodiments it may indicate C₍₁₎. This is summarized in Table 4 below.

TABLE 4

| Sign of s | Recovered Bit |
|---|---|
| s ≥ 0 | (0) |
| s < 0 | (1) |

Now an example of a unitarized PLSSP Two-Bit Codebook will be described. The unitarized PLSSP two-bit codebook is

$${C}_{( 0 , 0 )} = ( \begin{matrix}1 & 0 \\ 0 & 1\end{matrix} ) , \qquad {C}_{( 0 , 1 )} = ( \begin{matrix}0 & - 1 \\ 1 & 0\end{matrix} ) ,$$

$${C}_{( 1 , 0 )} = ( \begin{matrix}0 & 1 \\ - 1 & 0\end{matrix} ) , \qquad {C}_{( 1 , 1 )} = ( \begin{matrix}- 1 & 0 \\ 0 & - 1\end{matrix} ) .$$

Given received matrix Ĉ, the diversity distances between Ĉ and each matrix in the codebook are calculated as:

$${‖ \hat{C} - {C}_{( 0 , 0 )} ‖}_{D} = \vert det ( \hat{C} - {C}_{( 0 , 0 )} ) \vert .$$

Similarly, this is repeated for the rest of the two-bit options. From here, whichever codebook matrix has the smallest diversity distance from the received matrix identifies the codebook matrix to be recovered.

While diversity distance performs better for this codebook, Frobenius can still be used, and can be expressed as a computationally simpler recovery function. The same steps for the unitarized PLSSP one-bit codebook above can be followed to obtain the following recovery process. After obtaining Ĉ, the following two variables are calculated:

$${s}_{1} = Re {\hat{c}}_{11} + Re {\hat{c}}_{22} ,$$

$${s}_{2} = Re {\hat{c}}_{12} - Re {\hat{c}}_{21} .$$

The calculation of the first metric s₁ is the sum of the real portions of the elements along the main diagonal of Ĉ. The calculation of the second metric s₂ is the difference of the real portions of the elements along the anti-diagonal of Ĉ. Then, |s₁| and |s₂| are compared, selecting the larger one, and then the sign of the larger sᵢ is used to determine which bit string to recover, as shown in Table 5 below. It can be shown that this recovery approach performs the same as using the Frobenius approach, and it does not perform as well as using the diversity distance, but it may be easier to implement.

TABLE 5

| Largest \|sᵢ\| | Sign of sᵢ | Recovered Bits |
|---|---|---|
| \|s₁\| ≥ \|s₂\| | s₁ ≥ 0 | (0, 0) |
| | s₁ < 0 | (1, 1) |
| \|s₁\| < \|s₂\| | s₂ ≥ 0 | (1, 0) |
| | s₂ < 0 | (0, 1) |

Now an example of a unitarized PLSSP Three-Bit Codebook will be described. The unitarized PLSSP three-bit codebook is

$${C}_{( 0 , 0 , 0 )} = ( \begin{matrix}1 & 0 \\ 0 & 1\end{matrix} ) , \qquad {C}_{( 0 , 0 , 1 )} = ( \begin{matrix}0 & 1 \\ 1 & 0\end{matrix} ) ,$$

$${C}_{( 0 , 1 , 0 )} = ( \begin{matrix}0 & - 1 \\ 1 & 0\end{matrix} ) , \qquad {C}_{( 0 , 1 , 1 )} = ( \begin{matrix}- 1 & 0 \\ 0 & 1\end{matrix} ) ,$$

$${C}_{( 1 , 0 , 0 )} = ( \begin{matrix}0 & 1 \\ - 1 & 0\end{matrix} ) , \qquad {C}_{( 1 , 0 , 1 )} = ( \begin{matrix}1 & 0 \\ 0 & - 1\end{matrix} ) ,$$

$${C}_{( 1 , 1 , 0 )} = ( \begin{matrix}- 1 & 0 \\ 0 & - 1\end{matrix} ) , \qquad {C}_{( 1 , 1 , 1 )} = ( \begin{matrix}0 & - 1 \\ - 1 & 0\end{matrix} ) .$$

Given received matrix Ĉ, the squared Frobenius distances between Ĉ and each matrix in the codebook is calculated:

$${‖ \hat{C} - {C}_{( 0 , 0 , 0 )} ‖}_{F}^{2} = {\sum }_{i = 1}^{2} {\sum }_{j = 1}^{2} {\vert {\hat{c}}_{ij} - {c}_{( 0 , 0 , 0 ) ij} \vert}^{2} .$$

Similarly, this is repeated for the rest of the three-bit options (i.e., (0,0,1) . . . (1,1,1)). From here, whichever codebook has the smallest distance from the received codebook is recovered.

The Frobenius distance can be simplified into an equivalent recovery function with the same performance, as for the one-bit codebook described above. After obtaining Ĉ, the following four variables are calculated:

$${s}_{1} = Re {\hat{c}}_{11} + Re {\hat{c}}_{22} ,$$

$${s}_{2} = Re {\hat{c}}_{11} - Re {\hat{c}}_{22} ,$$

$${s}_{3} = Re {\hat{c}}_{12} + Re {\hat{c}}_{21} ,$$

$${s}_{4} = Re {\hat{c}}_{12} - Re {\hat{c}}_{21} .$$

The calculation of the first metric s₁ is the sum of the real portions of the elements along the main diagonal of Ĉ. The calculation of the second metric s₂ is the difference of the real portions of the elements along the main diagonal of Ĉ. The calculation of the third metric s₃ is the sum of the real portions of the elements along the anti-diagonal of Ĉ. The calculation of the fourth metric s₄ is the difference of the real portions of the elements along the anti-diagonal of Ĉ. Then, the sᵢ with greatest magnitude is selected, and then the sign of that largest sᵢ is used to determine which bit string to recover, as shown in Table 6 below.

TABLE 6

| Largest \|sᵢ\| | Sign of sᵢ | Recovered Bits |
|---|---|---|
| \|s₁\| | s₁ ≥ 0 | (0, 0, 0) |
| | s₁ < 0 | (1, 1, 0) |
| \|s₂\| | s₂ ≥ 0 | (1, 0, 1) |
| | s₂ < 0 | (0, 1, 1) |
| \|s₃\| | s₃ ≥ 0 | (0, 0, 1) |
| | s₃ < 0 | (1, 1, 1) |
| \|s₄\| | s₄ ≥ 0 | (1, 0, 0) |
| | s₄ < 0 | (0, 1, 0) |

Various specific examples of codebooks and recovery metrics have been described above for unitarized PLSSP. Other codebooks and recovery methods may be used for unitarized PLSSP as well that satisfy the requirement that the recovered codebook matrix entries are able to be accurately associated with an associated entry in the codebook to accurately determine the bits sent.

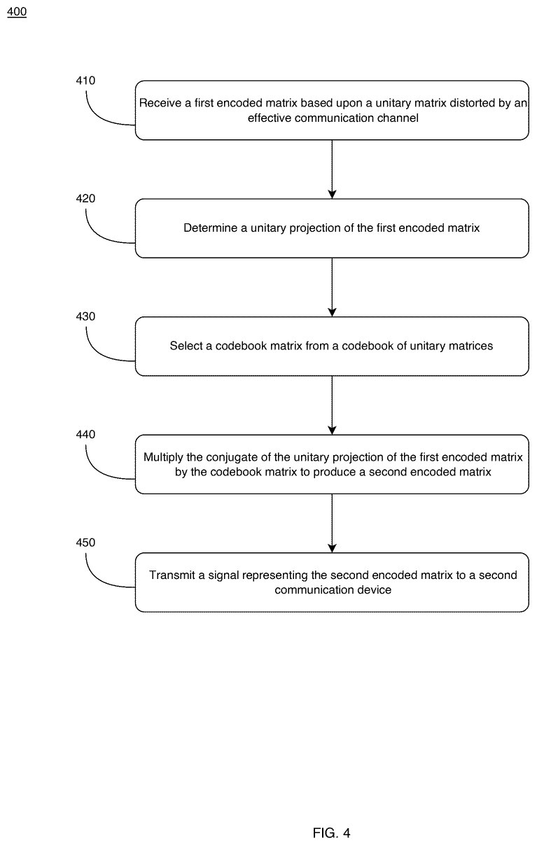

FIG. 4 is a flowchart illustrating an example process 400 performed by a first computing device, such as Bob in a unitarized PLSSP key exchange. At step 410, the first computing device receives a first encoded matrix based upon a unitary matrix distorted by an effective communication channel. In some examples, the unitary matrix may be a diagonal unitary matrix or a scalar multiple of an identity matrix.

At step 420, the first communication device determines a unitary projection of the first encoded matrix. In some examples, the first communication device may determine a unitary projection by finding a singular value decomposition or the polar decomposition of the first encoded matrix. At step 430, the first communication device selects a codebook matrix from a codebook of unitary matrices. The selected codebook matrix is associated with a message for transmission. For instance, the bit values of the index of the selected codebook matrix within the codebook of unitary matrices may be the message for transmission. In some examples, the codebook of unitary matrices is publicly available.

At step 440, the first communication device multiplies the conjugate of the unitary projection of the first encoded matrix by the codebook matrix to produce a second encoded matrix. For embodiments in which the unitary projection is determined by a singular value decomposition, multiplying the unitary projection of the first encoded matrix by the codebook matrix may include multiplying a transpose of the right singular matrix by the codebook matrix to produce an intermediate matrix, and multiplying a complex conjugate of the left singular matrix by the intermediate matrix to produce the second encoded matrix.

At step 450, the first communication device transmits a signal representing the second encoded matrix to a second communication device. In some examples, the first communication device may transmit additional encoded matrices to the second communication device until a predetermined number of messages have been sent. The additional encoded matrices may be transmitted on separate subcarriers and/or at different times than the second encoded matrix. Furthermore, the additional encoded matrices may be based on receiving more encoded matrices based on different unitary matrices distorted by the effective communication channel. In some examples, each encoded matrix received by the first communication device is based on a different unitary matrix distorted by the effective communication channel. In these examples, each additional transmitted encoded matrix may be based on a different received encoded matrix based on a different unitary matrix.

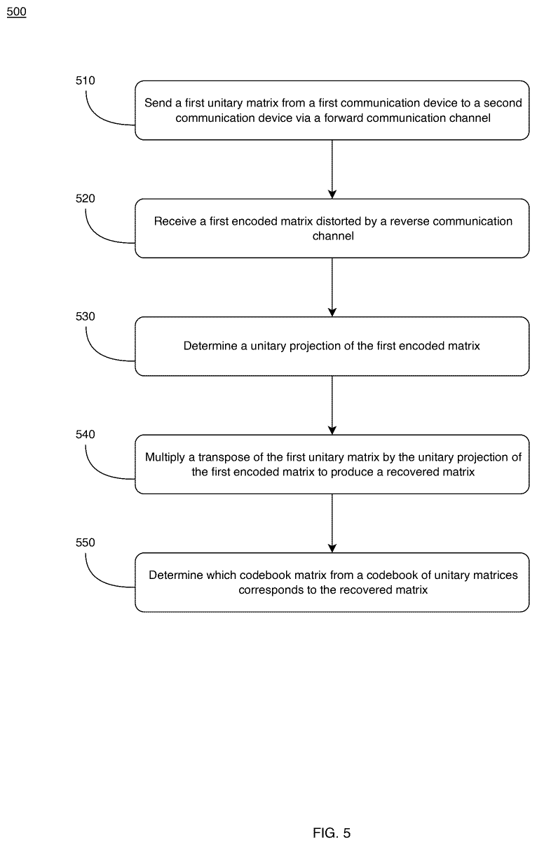

FIG. 5 is a flowchart illustrating an example process 500 performed by a first computing device, such as Alice in a unitarized PLSSP key exchange. At step 510, the first communication device sends a first unitary matrix from the first communication device to a second communication device via a forward communication channel (e.g., a wireless channel). In some examples, the first unitary matrix may be a diagonal unitary matrix or a scalar multiple of an identity matrix.

At step 520, the first communication device receives a first encoded matrix distorted by a reverse communication channel (e.g., a wireless channel) from the second communication device. The first encoded matrix is based upon the first unitary matrix distorted by the forward communication channel and a codebook matrix selected from a codebook of unitary matrices by the second communication device. In some examples, the codebook matrix is associated with a message for transmission. For instance, the bit values of the index of the selected codebook matrix within the codebook of unitary matrices may be the message for transmission.

At step 530, the first communication determines a unitary projection of the first encoded matrix. In some examples, the first communication device may determine a unitary projection by finding a singular value decomposition or the polar decomposition of the first encoded matrix.

At step 540, the first communication device multiplies a transpose of the first unitary matrix by the unitary projection of the first encoded matrix to produce a recovered matrix. For embodiments in which the unitary projection is determined by a singular value decomposition, multiplying the transpose of the first unitary matrix by the unitary projection of the first encoded matrix by the codebook matrix may include multiplying a transpose of the first unitary matrix by the left singular matrix to produce an intermediate matrix, and multiplying the intermediate matrix by a conjugate transpose of the right singular matrix to produce the recovered matrix.

At step 550, the first processor determines which codebook matrix from the codebook of unitary matrices corresponds to the recovered matrix. In some examples, the first communication device may determine which codebook matrix from the codebook of unitary matrices corresponds to the recovered matrix based on a distance measure (e.g., Frobenius distance, squared distance, diversity distance, etc.) between each codebook matrix and the recovered matrix.

In further examples, the first communication device may determine which codebook matrix from the codebook of unitary matrices corresponds to the recovered matrix based on one or more metrics calculated from elements of the recovered matrix. In these examples, the first communication device may compare one or more metrics to one or more predetermined thresholds

$$( e . g . , 0 , \frac{π}{2} , \frac{π}{4} , \pm \frac{2}{3} π , etc . )$$

to determine which metric is closest to the predetermined threshold or to determine the sign of a metric. Based on these comparisons, the first communication device may determine which codebook matrix corresponds to the recovered matrix.

If the codebooks for unitarized PLSSP are chosen carefully, a version of unitarized PLSSP may be obtained that is secure even when Eve is next to Alice and Bob, surpassing the original security properties of PLSSP. This version of unitarized PLSSP may be called single phase PLSSP. In this scheme the codebook information is sent encoded in a single global phase. That is, all codebook matrices differ only by a multiple of e^{iθ}. This restriction reduces the space of possible codebooks. That said, the optimal unitarized PLSSP one-bit codebook given for the one-bit unitarized PLSSP above already satisfies this global phase restriction, as it consists simply of I and −I. Therefore, unitarized PLSSP with the regular one-bit codebook is secure even when Eve is next to Alice and Bob.

It is important to note that if Eve is on both sides of the key exchange, she could send herself pilots and measure the channel H. This would allow Eve to break the security of the PLSSP exchange. However, this scenario also requires Eve to transmit energy, which could be detected. So, this means that a secure implementation would include a detector configured to detect unexpected energy in the subcarrier frequencies used to carry out the PLSSP exchange. Single phase PLSSP may be thought of as a generalization of a SISO scheme that is secure when Eve is next to both Alice and Bob. A SISO PLSSP will first be described, and then how the SISO PLSSP techniques can be extended to a MIMO channel will be described.

The SISO PLSSP starts by constructing a SISO OFDM key exchange which is secure even when Eve is on both sides. This will provide intuition for single phase PLSSP. Because Alice and Bob each have a single antenna, and OFDM is being used, the channel is given by a single coefficient, multiplication by some complex number

$$H = \vert H \vert {e}^{i h} .$$

Note that both the forward channel from Alice to Bob and the reverse channel from Bob to Alice are given by this coefficient. Following along the general PLSSP process, Alice will transmit a single complex number G=|G|e^{ig}, and Bob will receive

$$HG = \vert H \vert \vert G \vert {e}^{i ( h + g )} . \qquad ( 2 )$$

Bob will encode his key bits in a single complex number C=|C|e^{ic}, and combine it with the equation (2) to obtain a response R=|R|e^{ir}. When Bob transmits this to Alice, she receives

$$HR = \vert H \vert \vert R \vert {e}^{i ( h + r )} . \qquad ( 3 )$$

She will have to combine HR with her knowledge of G to recover the key bits.

Now, to make this scheme work, only the angles, or arguments, of the different complex numbers will be considered, ignoring any magnitudes. Note from equations (2) and (3) that these arguments are additive, and so the channel can be modelled in both directions as addition by some angle h. This makes it straightforward to construct an encryption and decryption scheme, built out of addition and subtraction of angles.

The steps of the key exchange for SISO PLSSP are as follows.

Step 1: Alice generates a uniformly random angle g that she keeps private.

Step 2: Alice transmits e^{ig} through the channel tap with angle h.

Step 3: Bob measures the angle of the received message, and gets h+g.

Step 4: Bob now encodes his message in an angle c. Bob computes his response r=c−(h+g) and sends e^{ir} over h.

Step 5: Alice measures the angle of the received response and gets h+r=c−g. Alice adds g to this to recover c, ĉ=g+(h+r).

Using SISO PLSSP, Eve recovers no information about c. It is observed that if Eve is on both sides, she sees h+g and c−g (magnitudes may be ignored, as they are not relevant to the process). Because h only appears in one of these expressions and is a uniformly random angle, Eve can gain no information from h+g. This leaves Eve with only c−g. Because g is uniformly random, Eve learns nothing about c.

As discussed above, it has been shown that security in SISO has been achieved when Eve is on both sides by encoding all information in a phase. This insight will now be applied to the unitarized PLSSP algorithm for a two-by-two MIMO channel. This is done by considering a codebook where matrices differ only by global phase multipliers of the form e^{iθ}. If the codebook includes the identity, then the matrices in the codebook may be written as

$$C ∈ {\{ {e}^{i {θ}_{j}} I \}}_{j} . \qquad ( 4 )$$

It will be seen why Eve learns nothing about which matrix C was sent with this codebook, like in the SISO version. By equation (4), C=cl can be written, where c=e^{iθ}^{ⱼ} for some j. So, c is just a global phase multiplier.

Given this set-up, Eve recovers no information about C.

Using the notation from the description of unitarized PLSSP above, after Alice sends G, Bob gets HG, which he transforms into ĤG (Ĥ= [symbol] is the unitary version of the channel) and incorporates this into his response to Alice,

$$R = {\hat{H}}^{*} {G}^{*} C = c {\hat{H}}^{*} {G}^{*} .$$

If Eve is on both sides of the key exchange, she will therefore receive
HG from Alice, and cH^{T} Ĥ*G* from Bob.

It can be shown that Eve learns nothing about c by observing these two received messages as these messages would be just as likely to occur for any c. It is observed that cG is just as likely to be picked by Alice as G; i.e., for each c, they are identically distributed:

$$G \sim cG .$$

Similarly, for each c, c*H and H are identically distributed:

$$H ∼ {c}^{*} H .$$

Making the substitutions G [symbol] cG and H [symbol] c*H into what Eve receives, it can be seen that her observations are distributed as

$$HG ↦ ( {c}^{*} H ) ( c G ) = HG and \qquad ( 5 )$$

$${cH}^{T} {\hat{H}}^{*} {G}^{*} ↦ {c ( {c}^{*} H )}^{T} {( {( {c}^{*} H )}^{𝒰} )}^{*} {( c G )}^{*} = {H}^{T} {\hat{H}}^{*} {G}^{*} \qquad ( 6 )$$

So, in fact, the distribution of what Eve observes in equations (5) and (6) does not depend on the sent c. Therefore, Eve learns nothing about c or C.

The single phase PLSSP algorithm is the same as the unitarized PLSSP as described above, with the restriction that the codebook matrices differ only by a global phase. When Alice gets Ĉ, she recovers to the closest valid multiple of the identity e^{iθ} I.

One difference from unitarized PLSSP is that the G picked by Alice in single phase PLSSP does not need to be sampled uniformly from the set of all unitary matrices. The distribution from which it is drawn just requires that the distributions of G and cG are similar. So, Alice might restrict G to the space of diagonal unitary matrices by generating random g₁, g₂∈ [symbol] and setting

$$G = ( \begin{matrix}{g}_{1} & 0 \\ 0 & {g}_{2}\end{matrix} ) .$$

Or, Alice might restrict G to the space of scalar multiples of the identity by picking a random g∈ [symbol] and setting

$$G = gI .$$

Examples of single phase PLSSP codebooks and recovery will now be described. It is relatively straightforward to design codebooks for single phase PLSSP and SISO PLSSP. In either case, the codespace is the set of angles [0,2π), which can be thought of as the unit circle [symbol] . For an n-bit codebook, 2ⁿ angles θᵢ are selected. These angles are spaced out uniformly to make the minimum distance as large as possible: every 0; will be a multiple of the angle

$$ω = \frac{2 π}{{2}^{n}} .$$

The only question is how to assign bitstrings to different points. A Gray code can be used to ensure that even if the estimate is off by one point, only one of the recovered bits is incorrect. Note the Gray coding sequence needs to be cyclic, in the sense that the first and last bitstrings need to differ only by one bit, as they will also be next to each other when arranged on the circle. For instance, consider the following three-bit Gray code sequence:
(0,0,0), (0,0,1), (0,1,1), (0,1,0), (1,1,0), (1,1,1), (1,0,1), (1,0,0)
   Note that the first element (0,0,0) and the last element (1,0,0) differ only in a single bit position.

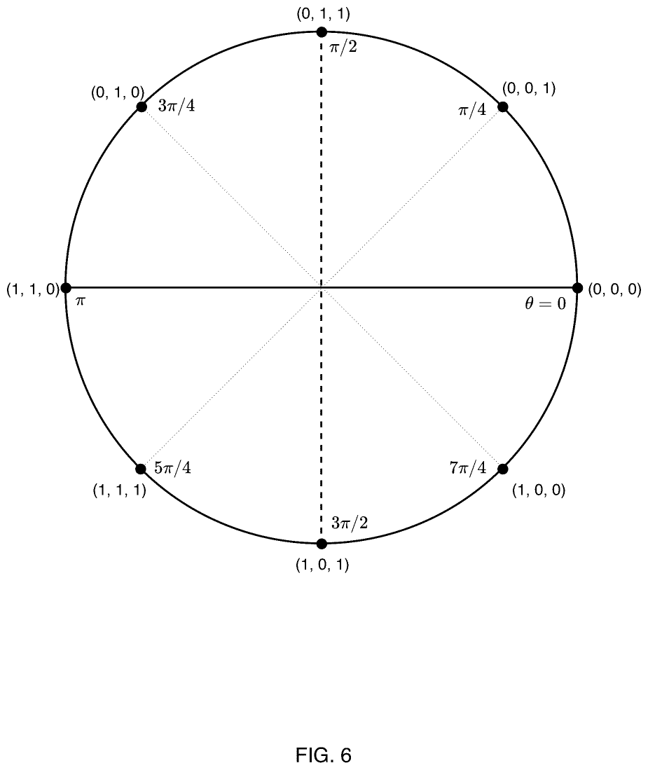

This Gray code sequence may be used to build codebooks for one, two, and three bits. For a three-bit codebook, the bit sequence is assigned to multiples of ω=2π/8=π/4. FIG. 6 illustrates how to assign angles θ to each combination of three bits. In FIG. 6, Gray codes are associated with eight angles around the unit circle to find a three-bit codebook for single phase PLSSP. Given a θ, the corresponding single phase PLSSP codebook matrix is e^{iθ} I. However, FIG. 6 may be used to find one-bit and two-bit codebooks. For one bit, the angles 0 and π are used, ignoring the dashed and dotted lines. The leftmost bit in each bitstring tells which bit to assign to the angle. For two bits, only multiples of π/2 are used (the solid and dashed lines, but not the dotted lines). The first two bits of each bitstring give a two-bit Gray coding and indicate how to assign the codebook angles.

The recovery process is straightforward: for SISO PLSSP, Alice receives an angle and identifies the closest multiple of ω, recovering the associated bitstring. For single phase PLSSP, Alice can also recover the bit string this same way, using a way of associating an angle to the received Ĉ. Alternatively, Alice may use any of the recovery algorithms using the distance measures to find the closest codebook matrix as discussed above.

The single phase PLSSP one-bit codebook is

$${C}_{( 0 )} = ( \begin{matrix}1 & 0 \\ 0 & 1\end{matrix} ) , \qquad {C}_{( 1 )} = ( \begin{matrix}- 1 & 0 \\ 0 & - 1\end{matrix} ) .$$

Note that this is the same codebook as described above with respect to unitarized PLSSP.

An embodiment of the single phase PLSSP two-bit codebook may be given by:

$${C}_{( 0 , 0 )} = ( \begin{matrix}1 & 0 \\ 0 & 1\end{matrix} ) , \qquad {C}_{( 0 , 1 )} = ( \begin{matrix}i & 0 \\ 0 & i\end{matrix} ) ,$$

$${C}_{( 1 , 0 )} = ( \begin{matrix}- i & 0 \\ 0 & - i\end{matrix} ) , \qquad {C}_{( 1 , 1 )} = ( \begin{matrix}- 1 & 0 \\ 0 & - 1\end{matrix} ) .$$

An embodiment of the single phase PLSSP three-bit codebook may be given by:

$${C}_{( 0 , 0 , 0 )} = ( \begin{matrix}1 & 0 \\ 0 & 1\end{matrix} ) , \qquad {C}_{( 0 , 0 , 1 )} = ( \begin{matrix}{e}^{i π / 4} & 0 \\ 0 & {e}^{i π / 4}\end{matrix} ) ,$$

$${C}_{( 0 , 1 , 0 )} = ( \begin{matrix}{e}^{i 3 π / 4} & 0 \\ 0 & {e}^{i 3 π / 4}\end{matrix} ) , \qquad {C}_{( 0 , 1 , 1 )} = ( \begin{matrix}i & 0 \\ 0 & i\end{matrix} ) ,$$

$${C}_{( 1 , 0 , 0 )} = ( \begin{matrix}- {e}^{i 3 π / 4} & 0 \\ 0 & - {e}^{i 3 π / 4}\end{matrix} ) , \qquad {C}_{( 1 , 0 , 1 )} = ( \begin{matrix}- i & 0 \\ 0 & - i\end{matrix} ) ,$$

$${C}_{( 1 , 1 , 0 )} = ( \begin{matrix}- 1 & 0 \\ 0 & - 1\end{matrix} ) , \qquad {C}_{( 1 , 1 , 1 )} = ( \begin{matrix}- {e}^{i π / 4} & 0 \\ 0 & - {e}^{i π / 4}\end{matrix} ) .$$

Various specific examples of codebooks and recovery metrics have been described above for single phase PLSSP. Other codebooks and recovery methods may be used for single phase PLSSP as well that satisfy the requirement that the recovered codebook matrix entries are able to be accurately associated with an associated entry in the codebook to accurately determine the bits sent.

Another embodiment of PLSSP will now be described that is called asymmetric PLSSP. In asymmetric PLSSP, Alice and Bob have a different number of antennas. In the examples below one will have one antenna and the other will have two antennas (but more than two may be used). Single Input Multiple Output (SIMO) PLSSP and a Multiple Input Single Output (MISO) PLSSP embodiments will be described. In a SIMO PLSSP embodiment, Alice has one antenna, and Bob has two antennas. In a MISO PLSSP embodiment, Alice has two antennas, and Bob has one antenna.

In SIMO PLSSP, the channel matrix only has two components h₁₁ and h₂₁. The channel components form the column vector

$$\vec{h} = ( \begin{matrix}{h}_{11} \\ {h}_{21}\end{matrix} ) .$$

However, the PLSSP MIMO algorithm operates on a two-by-two H matrix. The two-by-two H matrix may be created by copying the column vector \vec{h} twice:

$$H = ( \begin{matrix}{h}_{11} \\ {h}_{21}\end{matrix} ) ( 11 ) = ( \begin{matrix}{h}_{11} & {h}_{11} \\ {h}_{21} & {h}_{21}\end{matrix} ) . \qquad ( 7 )$$

MISO PLSSP also only has two H components but this time their components form the row vector \vec{h}=(h₁₁ h₁₂).

Here the two-by-two H matrix is created by copying the row vector twice:

$$H = ( \begin{matrix}1 \\ 1\end{matrix} ) ( \begin{matrix}{h}_{11} & {h}_{12}\end{matrix} ) = ( \begin{matrix}{h}_{11} & {h}_{12} \\ {h}_{11} & {h}_{12}\end{matrix} ) . \qquad ( 8 )$$

In both cases, H is singular because its columns are now dependent. Not all PLSSP codebooks work with a singular channel matrix. Therefore, codebooks are needed specifically for asymmetric PLSSP.

SIMO PLSSP retains the same security as original PLSSP except when an eavesdropper is located next to Alice. This way, Eve experiences the same channel from Bob as Alice. If this occurs, then Eve is able to extract C from the exchange with some certainty. Further, if Eve is allowed to have an antenna next to Alice as well as multiple antennas not necessarily near Bob or Alice, her confidence in finding C increases.

The SIMO PLSSP will now be described. Suppose Alice is transmitting with one antenna, and Bob is receiving with two. The SIMO algorithm primarily follows the same steps as original PLSSP, except for a few small changes to account for the missing antenna. The following steps are equivalent to making a channel matrix H that contains two copies of h and using that in the regular original PLSSP algorithm.

Step 1: Alice generates a two-by-two complex unitary matrix G and keeps it private.
Recall, the normal MIMO unitary matrix has the form

$$G = ( \begin{matrix}{g}_{11} & {g}_{12} \\ {g}_{21} & {g}_{22}\end{matrix} )$$

where the rows are split across antennas and the columns are split across time. However, in this set up, Alice only has one antenna. Therefore, she has to modify her G matrix into a vector.

Step 2: Alice left matrix multiplies G by the row vector (1,1).
The G matrix becomes the vector

$$\vec{g} = ( 11 ) G = ( \begin{matrix}{g}_{11} + {g}_{21} & {g}_{12} + {g}_{22}\end{matrix} ) .$$

As discussed above, the channel matrix H is no longer its full original form

$$H = ( \begin{matrix}{h}_{11} & {h}_{12} \\ {h}_{21} & {h}_{22}\end{matrix} )$$

either. Instead, the \vec{g} vector will only be affected by the column vector

$$\vec{h} = ( \begin{matrix}{h}_{11} \\ {h}_{21}\end{matrix} ) .$$

Step 3: Bob receives \vec{h}\vec{g} and performs an SVD on it: \vec{h}\vec{g}↔(U_{b}, D_{b}, V_{b}).

$$\begin{matrix}\vec{h} \vec{g} = ( \begin{matrix}{h}_{11} \\ {h}_{21} )\end{matrix} ( \begin{matrix}{g}_{11} + {g}_{21} & {g}_{12} + {g}_{22}\end{matrix} ) \\ = ( \begin{matrix}{h}_{11} ( {g}_{11} + {g}_{21} ) & {h}_{11} ( {g}_{12} + {g}_{22} ) \\ {h}_{21} ( {g}_{11} + {g}_{21} ) & {h}_{21} ( {g}_{12} + {g}_{22} )\end{matrix} ) \\ ↔ ( {U}_{b} , {D}_{b} , {V}_{b} ) .\end{matrix}$$

Note that even though \vec{g} is only affected by the column vector \vec{h}, this can be written as

$$\vec{h} \vec{g} = \vec{h} ( 1 , 1 ) G = HG ,$$

in terms of the two-by-two H defined in (7).

Step 4: Bob encodes a message from a codebook as a matrix C, using an Asymmetric codebook as described below.

Step 5: Bob uses C to create

$$R = {U}_{b}^{*} C {V}_{b}^{†} .$$

Since Bob has two antennas,

$$R = ( \begin{matrix}{r}_{11} & {r}_{12} \\ {r}_{21} & {r}_{22}\end{matrix} )$$

as before.

Step 6: Bob sends R over \vec{h}^{T}.
In this case, \vec{h}^{T} is the row vector

$${\vec{h}}^{T} = ( \begin{matrix}{h}_{11} & {h}_{21}\end{matrix} ) .$$

### So

$$\begin{matrix}{\vec{h}}^{T} R = ( \begin{matrix}{h}_{11} & {h}_{21}\end{matrix} ) ( \begin{matrix}{r}_{11} & {r}_{12} \\ {r}_{21} & {r}_{22}\end{matrix} ) \\ = ( \begin{matrix}{h}_{11} {r}_{11} + {h}_{21} {r}_{21} & {h}_{11} {r}_{12} + {h}_{21} {r}_{22}\end{matrix} ) .\end{matrix}$$

In order to continue the PLSSP algorithm, Alice needs to SVD a two-by-two matrix.

Step 7: Alice receives \vec{h}^{T}R and left multiplies \vec{h}^{T}R by the column vector

$$( \begin{matrix}1 \\ 1\end{matrix} ) .$$

This yields

$$( \begin{matrix}1 \\ 1\end{matrix} ) {\vec{h}}^{T} R = {[ \vec{h} ( 1 , 1 ) ]}^{T} R = {H}^{T} R ,$$

so the operation can be expressed again in terms of H.

Step 8: Alice takes the SVD of the H^{T} R matrix: H^{T} R↔(Uₐ, Dₐ, Vₐ).

Step 9: Alice calculates

$$\hat{C} = {V}_{a}^{†} {G}^{†} {U}_{a}^{*} .$$

Even in a noiseless environment, only the magnitudes of Ĉ match the C sent by Bob as the phases will be distorted.

Step 10: Alice recovers the original C using the Asymmetric recovery method described below.

Now a MISO PLSSP embodiment will be described where Alice is transmitting with two antennas and Bob is receiving with one.

Step 1: Alice generates complex, unitary matrix G and keeps it private.

$$G = ( \begin{matrix}{g}_{11} & {g}_{12} \\ {g}_{21} & {g}_{22}\end{matrix} ) .$$

G will be affected by the channel as represented by the row vector

$$\vec{h} = ( \begin{matrix}{h}_{11} & {h}_{12}\end{matrix} ) .$$

After traversing the channel, Bob receives

$$\vec{h} G = ( \begin{matrix}{h}_{11} {g}_{11} + {h}_{12} {g}_{21} & {h}_{11} {g}_{12} + {h}_{12} {g}_{22}\end{matrix} ) .$$

In order to take the SVD of this, Bob must convert this row into a matrix.

Step 2: Bob receives \vec{h}G and left matrix multiples it by the column vector

$$( \begin{matrix}1 \\ 1\end{matrix} )$$

to expand it to a matrix.
He gets

$$( \begin{matrix}1 \\ 1\end{matrix} ) \vec{h} G = H G ,$$

so that this can be written in terms of the two-by-two H defined in equation (8).

Step 3: Bob performs an SVD on the matrix HG: HG↔(U_{b}, D_{b}, V_{b}).

Step 4: Bob encodes a message from a codebook matrix C using the Asymmetric codebook.

Step 5: Bob uses C to create

$$R = {U}_{b}^{*} C {V}_{b}^{†} .$$

Originally Bob makes

$$R = ( \begin{matrix}{r}_{11} & {r}_{12} \\ {r}_{21} & {r}_{22}\end{matrix} ) .$$

However, Bob only has one antenna. So, Bob has to convert this matrix into a row vector.

Step 6: Bob left matrix multiples R by the row vector (1 1).
The R matrix becomes

$$\vec{r} = ( \begin{matrix}1 & 1\end{matrix} ) R = ( \begin{matrix}{r}_{11} + {r}_{21} & {r}_{12} + {r}_{22}\end{matrix} ) .$$

Step 7: Bob sends \vec{r} over \vec{h}^{T}.
In this case, \vec{h}^{T} is the column vector

$${\vec{h}}^{T} = ( \begin{matrix}{h}_{11} \\ {h}_{12}\end{matrix} ) .$$

### So,

$${\vec{h}}^{T} \vec{r} = ( \begin{matrix}{h}_{11} \\ {h}_{12}\end{matrix} ) ( \begin{matrix}{r}_{11} + {r}_{21} & {r}_{12} + {r}_{22}\end{matrix} ) = ( \begin{matrix}{h}_{11} ( {r}_{11} + {r}_{21} ) & {h}_{11} ( {r}_{12} + {r}_{22} ) \\ {h}_{12} ( {r}_{11} + {r}_{21} ) & {h}_{12} ( {r}_{12} + {r}_{22} )\end{matrix} ) .$$

This can also be written as

$$\begin{matrix}{\vec{h}}^{T} \vec{r} = {\vec{h}}^{T} ( 1 , 1 ) R \\ = {[ ( \begin{matrix}1 \\ 1\end{matrix} ) \vec{h} ]}^{T} R \\ = {H}^{T} R\end{matrix} ,$$

so, the operation is in terms of the two-by-two H.

Step 8: Alice receives \vec{h}^{T}\vec{r} and performs an SVD on it: \vec{h}^{T}\vec{r}↔(Uₐ, Dₐ, Vₐ).

Step 9: Alice calculates

$$\hat{C} = {V}_{a}^{†} {G}^{†} {U}_{a}^{*} .$$

As in SIMO PLSSP, only the magnitudes of the entries in Ć will match C.

Step 10: Alice recovers the original C using the Asymmetric recovery method discussed in the next section.

Examples of asymmetric PLSSP codebooks and recovery methods will now be described. Note that the same codebooks can be used for MISO PLSSP and SIMO PLSSP. It can be shown that if H is singular, then when Bob sends a matrix C, Alice receives a distorted unitary version of C where the angles of all the entries are random. Only information about the magnitudes of the entries is preserved. Therefore, codebooks that only encode information in the magnitudes and not the phases will be chosen for asymmetric PLSSP. The codebooks may be chosen to be the unitary matrices:

$${C}_{i} = ( \begin{matrix}cos {θ}_{i} & sin {θ}_{i} \\ - sin {θ}_{i} & cos {θ}_{i}\end{matrix} ) .$$

To create such a codebook, it is first determined how many bits are to be conveyed per symbol. Then, each symbol is mapped to a value of θ between zero and π/2. The more spread apart the values of θ are, the better the codebook will be because increased spacing between the symbols leads to an increased ability to distinguish the received symbols.

To recover these codebooks, suppose the following unitary matrix is obtained:

$$\hat{C} = ( \begin{matrix}{\hat{c}}_{11} & {\hat{c}}_{12} \\ {\hat{c}}_{21} & {\hat{c}}_{22}\end{matrix} ) .$$

Then compute the following

$$arccos \vert {\hat{c}}_{11} \vert$$

and compare it to the θ values for all the possible codebook matrices. Approximate the codebook matrix with the closest θ value to arccos |ĉ₁₁| as the transmitted codebook matrix. Note that nothing will be gained from incorporating other entries of Ĉ into the recovery, because Ĉ being unitary implies that the other entries are dependent on ĉ₁₁, specifically that |ĉ₁₁|²=|ĉ₂₂|², |ĉ₁₂|²=|ĉ₂₁|², and |ĉ₁₁|²+|ĉ₁₂|²=1.

An embodiment of an Asymmetric PLSSP one-bit codebook will now be described. A one-bit asymmetric codebook will have the mapping shown in table 7 below.

TABLE 7

| Bit | θ |
|---|---|
| (0) | 0 |
| (1) | π/2 |

Using that mapping, the following two codebook matrices result.

$${C}_{( 0 )} = ( \begin{matrix}1 & 0 \\ 0 & 1\end{matrix} ) , {C}_{( 1 )} = ( \begin{matrix}0 & 1 \\ - 1 & 0\end{matrix} )$$

An embodiment of a two-bit Asymmetric codebook will have the mapping shown in table 8 below.

TABLE 8

| θ | Bits |
|---|---|
| 0 | (0, 0) |
| π/6 | (0, 1) |
| π/3 | (1, 1) |
| π/2 | (1, 0) |

Notice how the bits here are mapped using gray encoding so that a symbol error translates to one bit error. Using that mapping, the following four codebook matrices result.

$${C}_{( 0 , 0 )} = ( \begin{matrix}1 & 0 \\ 0 & 1\end{matrix} ) ;$$

$${C}_{( 0 , 1 )} = ( \begin{matrix}\frac{\sqrt{3}}{2} & \frac{1}{2} \\ \frac{- 1}{2} & \frac{\sqrt{3}}{2}\end{matrix} ) ;$$

$${C}_{( 1 , 1 )} = ( \begin{matrix}\frac{1}{2} & \frac{\sqrt{3}}{2} \\ \frac{- \sqrt{3}}{2} & \frac{1}{2}\end{matrix} ) ;$$

$${C}_{( 1 , 0 )} = ( \begin{matrix}0 & 1 \\ - 1 & 0\end{matrix} ) .$$

An embodiment of a three-bit asymmetric codebook will have the mapping shown in table 9 below.

TABLE 9

| θ | Bits |
|---|---|
| 0 | (0, 0, 0) |
| π/14 | (0, 0, 1) |
| π/7 | (0, 1, 1) |
| 3π/14 | (0, 1, 0) |
| 2π/7 | (1, 1, 0) |
| 5π/14 | (1, 1, 1) |
| 3π/7 | (1, 0, 1) |
| π/2 | (1, 0, 0) |

Again, the bits are coded using gray coding so a symbol error with the next nearest symbol translates to a single bit error. Using that mapping, the following eight codebook matrices result.

$${C}_{( 0 , 0 , 0 )} = ( \begin{matrix}1 & 0 \\ 0 & 1\end{matrix} ) ;$$

$${C}_{( 0 , 0 , 1 )} = ( \begin{matrix}0.975 & 0.223 \\ - 0.223 & 0.975\end{matrix} ) ;$$

$${C}_{( 0 , 1 , 1 )} = ( \begin{matrix}0.901 & 0.434 \\ - 0.434 & 0.901\end{matrix} ) ;$$

$${C}_{( 0 , 1 , 0 )} = ( \begin{matrix}0.782 & 0.623 \\ - 0.623 & 0.782\end{matrix} ) ;$$

$${C}_{( 1 , 1 , 0 )} = ( \begin{matrix}0.623 & 0.782 \\ - 0.782 & 0.623\end{matrix} ) ;$$

$${C}_{( 1 , 1 , 1 )} = ( \begin{matrix}0.434 & 0.901 \\ - 0.901 & 0.434\end{matrix} ) ;$$

$${C}_{( 1 , 0 , 1 )} = ( \begin{matrix}0.223 & 0.975 \\ - 0.975 & 0.223\end{matrix} ) ;$$

$${C}_{( 1 , 0 , 0 )} = ( \begin{matrix}0 & 1 \\ - 1 & 0\end{matrix} ) .$$

Various specific examples of codebooks and recovery metrics have been described above for asymmetric PLSSP. Other codebooks and recovery methods may be used for asymmetric PLSSP as well that satisfy the requirement that the recovered codebook matrix entries are able to be accurately associated with an associated entry in the codebook to accurately determine the bits sent.

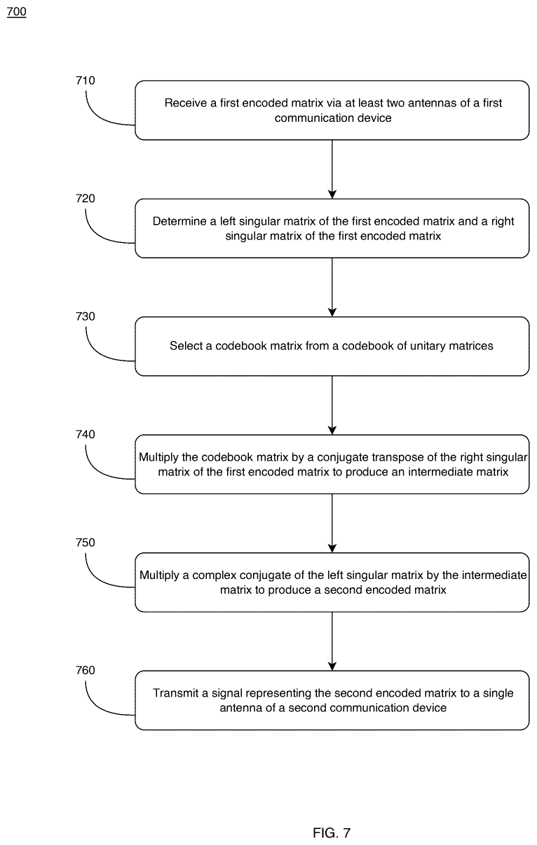

FIG. 7 is a flowchart illustrating an example process 700 of the steps carried out by a first computing device, such as Bob in a SIMO PLSSP key exchange. At step 710, the first communication device receives, via at least two antennas, a first encoded matrix based upon a unitary matrix. Each row of the first encoded matrix corresponds to a first encoded vector transmitted from a single antenna of a second communication device and received by a corresponding antenna of the at least two antennas of the first communication device. In some examples, the unitary matrix may be a diagonal unitary matrix or a scalar multiple of an identity matrix.

At step 720, the first communication device determines a left singular matrix of the first encoded matrix and a right singular matrix of the first encoded matrix. In some examples, the first communication device performs a singular value decomposition to determine the left singular matrix and the right singular matrix. At step 730, the first communication device selects a codebook matrix from a codebook of unitary matrices, for a message for transmission. In some examples, the message for transmission is based on an index within the codebook of unitary matrices corresponding to the selected codebook matrix.

At step 740, the first communication device multiplies the codebook matrix by a conjugate transpose of the right singular matrix of the first encoded matrix to produce an intermediate matrix. At step 750, the first communication device multiplies a complex conjugate of the left singular matrix of the first encoded matrix by the intermediate matrix to produce a second encoded matrix. At step 760, the first communication device transmits a signal representing the second encoded matrix to the single antenna of a second communication device. In some examples, the first communication device may produce and transmit additional encoded matrices to the second communication device until a predetermined number of messages has been sent. For instance, each message may be associated with a predetermined number of bits (e.g., a three bit index value identifying one codebook matrix among a codebook of eight unitary matrices), and the predetermined number of messages may be sufficient to convey a cryptographic key of a predetermined length (e.g., 256 bits).

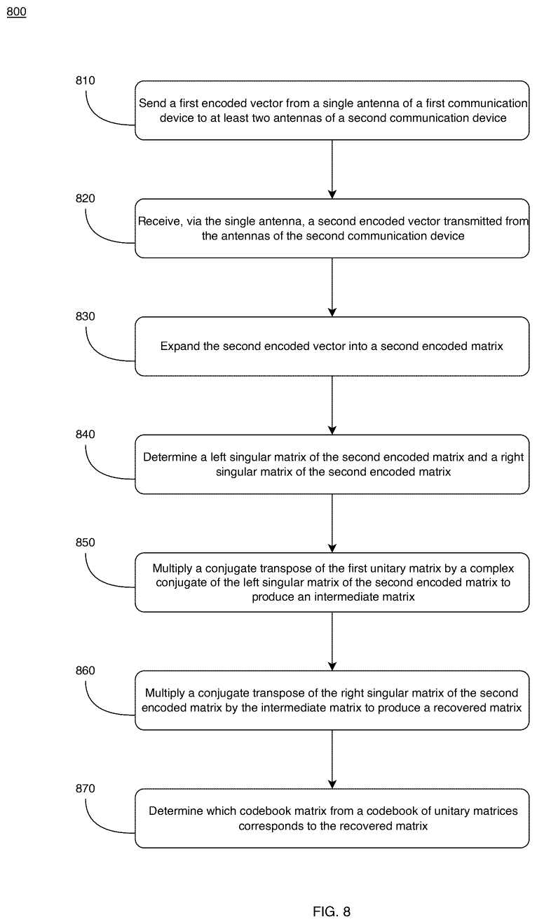

FIG. 8 is a flowchart illustrating an example process 800 carried out by a first computing device, such as Alice in a SIMO PLSSP key exchange. At step 810, the first communication device sends a first encoded vector based on a first unitary matrix from a single antenna of the first communication device to at least two antennas of a second communication device. In some examples, the unitary matrix may be a diagonal unitary matrix or a scalar multiple of an identity matrix.

At step 820, the first communication device receives, via the single antenna of the first communication device, a second encoded vector from the at least two antennas of the second communication device. The second encoded vector is based upon the first unitary matrix, a codebook matrix, and a representation of an effective channel, wherein the codebook matrix is one of a codebook of unitary matrices. In some examples, the representation of the effective channel is represented in a distortion of the first unitary matrix as received by the second communication device caused by a wireless channel and/or a distortion of a second encoded matrix transmitted by the at least two antennas of the second communication device.

At step 830, the first communication device expands the second encoded vector into a second encoded matrix. In some examples, the first communication device expands the second encoded vector into a second encoded matrix by duplicating the second encoded vector as rows of the second encoded matrix. At step 840, the first communication device determines a left singular matrix of the second encoded matrix and a right singular matrix of the second encoded matrix. In some examples, the first communication device performs a singular value decomposition to determine the left singular value and the right singular value.

At step 850, the first communication device multiplies a conjugate transpose of the first unitary matrix by a complex conjugate the left singular matrix of the second encoded matrix to produce an intermediate matrix. At step 860, the first communication device multiplies a conjugate transpose of the right singular matrix of the second encoded matrix by the intermediate matrix to produce a recovered matrix.

At step 870, the first processor determines which codebook matrix from the codebook of unitary matrices corresponds to the recovered matrix. In some examples, the first communication device may determine which codebook matrix from the codebook of unitary matrices corresponds to the recovered matrix based on a distance measure (e.g., Frobenius distance, squared distance, diversity distance, etc.) between each codebook matrix and the recovered matrix. Additionally or alternatively, the first processor may process one or more elements of the recovered matrix (e.g., calculate an arccosine of the magnitude of a recovered matrix element, take the absolute value of a recovered matrix element, add or subtract elements, etc.) to determine a metric of the recovered matrix. The first processor may then determine which codebook matrix corresponds to the recovered matrix by comparing a distance between the metric of the recovered matrix and one or more predetermined thresholds based on the corresponding metrics of each of the codebook matrices.

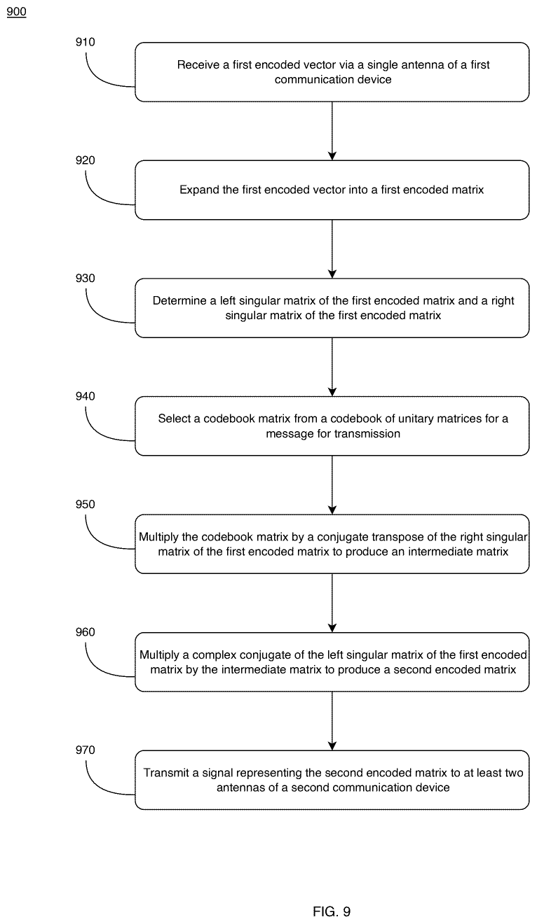

FIG. 9 is a flowchart illustrating an example process 900 carried out by a first communication device, such as Bob in a MISO PLSSP key exchange. At step 910, the first communication device receives a first encoded vector via a single antenna. The first encoded vector is based upon a unitary matrix that is transmitted by at least two antennas of a second communication device and distorted by an effective channel. In some examples, the unitary matrix may be a diagonal unitary matrix or a scalar multiple of an identity matrix.

At step 920, the first communication device expands the first encoded vector into a first encoded matrix. In some examples, the first communication device expands the first encoded vector into the first encoded matrix by duplicating the first encoded vector as rows of the first encoded matrix.

At step 930, the first communication device determines a left singular matrix of the first encoded matrix and a right singular matrix of the first encoded matrix. In some examples, the first communication device performs a singular value decomposition of the first encoded matrix to determine the left singular matrix and the right singular matrix. At step 940, the first communication device selects a codebook matrix from a codebook of unitary matrices, for a message for transmission. In some examples, the message for transmission is based on an index within the codebook of unitary matrices corresponding to the selected codebook matrix.

At step 950, the first communication device multiplies the codebook matrix by a conjugate transpose of the right singular matrix of the first encoded matrix to produce an intermediate matrix. At step 960, the first communication device multiplies a complex conjugate of the left singular matrix of the first encoded matrix by the intermediate matrix to produce a second encoded matrix.

At step 970, the first communication device transmits a signal representing the second encoded matrix to at least two antennas of a second communication device. In some examples, the first communication device converts the second encoded matrix to a second encoded vector before transmitting the signal via the single antenna of the first communication device. For instance, the first communication device may sum the values of each column of the second encoded matrix to produce the second encoded vector as a row vector.

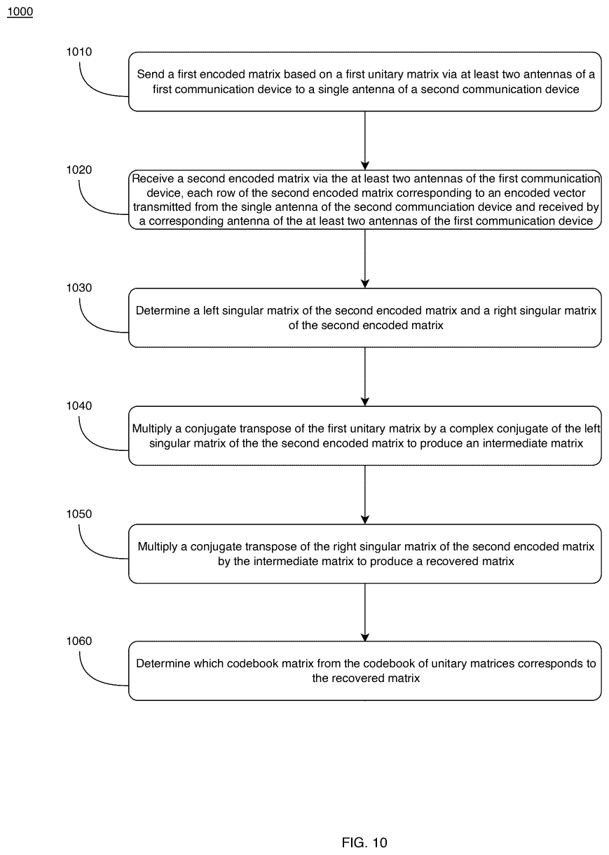

FIG. 10 is a flowchart illustrating an example 1000 carried out by a first communication device, such as Alice in a MISO PLSSP key exchange. At step 1010, the first communication device sends a first encoded matrix via at least two antennas of the first communication device to a single antenna of a second communication device. The first encoded matrix is based on a first unitary matrix. In some examples, the first unitary matrix may be a diagonal unitary matrix or a scalar multiple of an identity matrix.

At step 1020, the first communication device receives a second encoded matrix via the at least two antennas of the first communication device. Each row of the second encoded matrix corresponds to an encoded vector transmitted from the single antenna of the second communication device. The encoded vector is based upon the first unitary matrix distorted by an effective channel and a codebook matrix selected from a codebook of unitary matrices.

At step 1030, the first communication device determines a left singular matrix of the second encoded matrix and a right singular matrix of the second encoded matrix. In some examples, the first communication device performs a singular value decomposition of the second encoded matrix to determine the left singular matrix and the right singular matrix.

At step 1040, the first communication device multiplies a conjugate transpose of the first unitary matrix by a complex conjugate of the left singular matrix of the second encoded matrix to produce an intermediate matrix. At step 1050, the first communication device multiplies a conjugate transpose of the right singular matrix of the second encoded matrix by the intermediate matrix to produce a recovered matrix.

At step 1060, the first processor determines which codebook matrix from the codebook of unitary matrices corresponds to the recovered matrix. In some examples, the first communication device may determine which codebook matrix from the codebook of unitary matrices corresponds to the recovered matrix based on a distance measure (e.g., Frobenius distance, squared distance, diversity distance, etc.) between each codebook matrix and the recovered matrix. Additionally or alternatively, the first processor may process one or more elements of the recovered matrix (e.g., calculate an arccosine of the magnitude of a recovered matrix element, take the absolute value of a recovered matrix element, add or subtract elements, etc.) to determine a metric of the recovered matrix. The first processor may then determine which codebook matrix corresponds to the recovered matrix by comparing a distance between the metric of the recovered matrix and one or more predetermined thresholds based on the corresponding metrics of each of the codebook matrices.

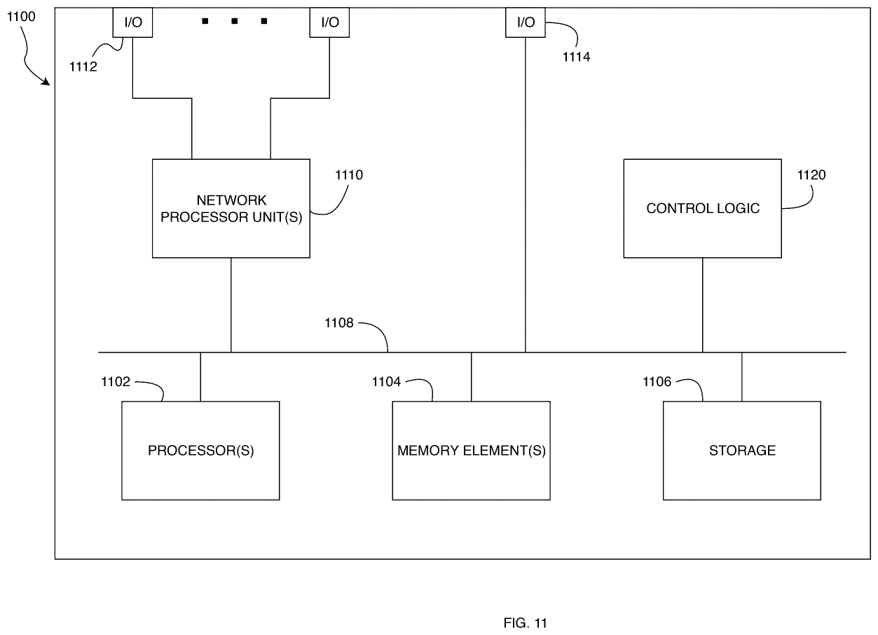

Referring now to FIG. 11, a hardware block diagram depicts a computing device 1100 that may perform functions associated with operations described herein in connection with the techniques depicted in FIGS. 1-10. In various embodiments, a computing device, such as computing device 1100 or any combination of computing devices 1100, may be configured as any entity/entities as discussed for the techniques depicted in connection with FIGS. 1-10 in order to perform operations of the various techniques discussed herein. In some instances, one or more computing devices 1100 (e.g., servers) may be deployed in a cloud or distributed computing environment to perform one or more of the techniques described herein.

In at least one embodiment, the computing device 1100 may include one or more processor(s) 1102, one or more memory element(s) 1104, storage 1106, a communication bus 1108, one or more network processor unit(s) 1110 interconnected with one or more network input/output (I/O) interface(s) 1112, and control logic 1120. In various embodiments, instructions associated with logic for computing device 1100 may overlap in any manner and are not limited to the specific allocation and/or operations described herein.

In at least one embodiment, processor(s) 1102 is/are at least one hardware processor configured to execute various tasks, operations, and/or functions for computing device 1100 as described herein according to software and/or instructions configured for computing device 1100. Processor(s) 1102 (e.g., a hardware processor) can execute any type of instructions associated with data to achieve the operations detailed herein. In one example, processor(s) 1102 can transform an element or an article (e.g., data, information, etc.) from one state or thing to another state or thing. Any of potential processing elements, microprocessors, digital signal processors, floating point gate arrays (FPGAs), graphical processor units (GPUs), secure processors, baseband signal processors, modems, PHY elements, controllers, systems, managers, logic, and/or machines described herein can be construed as being encompassed within the broad term ‘processor.’

In at least one embodiment, memory element(s) 1104 and/or storage 1106 is/are configured to store data, information, software, and/or instructions associated with computing device 1100, and/or logic configured for memory element(s) 1104 and/or storage 1106. For example, any logic described herein (e.g., control logic 1120) can, in various embodiments, be stored for computing device 1100 using any combination of memory element(s) 1104 and/or storage 1106. Note that in some embodiments, storage 1106 can be consolidated with memory element(s) 1104 (or vice versa), or can overlap/exist in any other suitable manner.

In at least one embodiment, communication bus 1108 can be configured as an interface that enables one or more elements of computing device 1100 to communicate in order to exchange information and/or data. Communication bus 1108 can be implemented with any architecture designed for passing control, data, and/or information between processors, memory elements/storage, peripheral devices, and/or any other hardware and/or software components that may be configured for computing device 1100. In at least one embodiment, communication bus 1108 may be implemented as a fast kernel-hosted interconnect, potentially using shared memory between processes (e.g., logic), which can enable efficient communication paths between the processes.

In various embodiments, network processor unit(s) 1110 may enable communication between computing device 1100 and other systems, entities, etc., via network I/O interface(s) 1112 (wired and/or wireless) to facilitate operations discussed for various embodiments described herein. In various embodiments, network processor unit(s) 1110 can be configured as a combination of hardware and/or software, such as one or more Ethernet driver(s) and/or controller(s) or interface card(s), optical (e.g., Fibre Channel) driver(s) and/or controller(s), wireless receivers/transmitters/transceivers, baseband processor(s)/modem(s), and/or other similar network interface driver(s) and/or controller(s) now known or hereafter developed to enable communications between computing device 1100 and other systems, entities, etc., to facilitate operations for various embodiments described herein. In various embodiments, network I/O interface(s) 1112 can be configured as one or more Ethernet port(s), Fibre Channel port(s), and/or antenna(s)/antenna array(s) now known or hereafter developed. Thus, the network processor unit(s) 1110 and/or network I/O interface(s) 1112 may include suitable interfaces for receiving, transmitting, and/or otherwise communicating data and/or information in a network environment.

I/O interface(s) 1114 allow for input and output of data and/or information with other entities that may be connected to computing device 1100. For example, I/O interface(s) 1114 may provide a connection to external devices such as a keyboard, keypad, touch screen, microphone or microphone array, camera, video capture device, and/or other suitable input and/or output device now known or hereafter developed. In some instances, external devices may also include portable computer readable (non-transitory) storage media such as database systems, flash memory drives, portable optical or magnetic disks, and/or other memory cards. In some instances, external devices may include a mechanism to display data to a user, such as a computer monitor, a display screen, an audio speaker, and/or other output device.

In various embodiments, control logic 1120, can include instructions that, when executed, cause processor(s) 1102 to perform operations, which can include, but not be limited to, providing overall control operations of computing devices; interacting with other entities, systems, etc., described herein; maintaining and/or interacting with stored data, information, parameters, etc. (e.g., memory element(s), storage, data structures, databases, tables, etc.); combinations thereof, and/or the like to facilitate various operations for embodiments described herein.

The programs described herein (e.g., control logic 1120) may be identified based upon application(s) for which they are implemented in a specific embodiment. However, it should be appreciated that any particular program nomenclature herein is used merely for convenience; thus, embodiments herein should not be limited to use(s) solely described in any specific application(s) identified and/or implied by such nomenclature.

In various embodiments, entities as described herein may store data/information in any suitable volatile and/or non-volatile memory item (e.g., magnetic hard disk drive, solid state hard drive, semiconductor storage device, random access memory (RAM), read only memory (ROM), erasable programmable read only memory (EPROM), secure memory module, tamper-proof memory, application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term ‘memory element’. Data/information being tracked and/or sent to one or more entities as discussed herein could be provided in any database, table, register, list, cache, storage, and/or storage structure; all of which can be referenced at any suitable timeframe. Any such storage options may also be included within the broad term ‘memory element’ as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in an Application Specific Integrated Circuit (ASIC), Digital Signal Processing (DSP) instructions, software (potentially inclusive of object code and/or source code), etc.) for execution by one or more processor(s), and/or other similar machines. Generally, memory element(s) 1104 and/or storage 1106 may store data, software, code, instructions (e.g., processor instructions), logic, parameters, combinations thereof, and/or the like used for operations described herein. This includes memory element(s) 1104 and/or storage 1106 being able to store data, software, code, instructions (e.g., processor instructions), logic, parameters, combinations thereof, and/or the like that are executed to carry out operations in accordance with the teachings of the present disclosure.

In some instances, software of the present embodiments may be available via a non-transitory computer useable medium (e.g., magnetic or optical mediums, magneto-optic mediums, CD-ROM, DVD, memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, flash drives, and/or smart cards that can be inserted and/or otherwise connected to a computing device for transfer onto another computer readable storage medium.

### VARIATIONS AND IMPLEMENTATIONS

The embodiments described herein are described using two-by-two MIMO systems and hence two-by-two matrices. These embodiments may be extended to embodiments with larger MIMO systems and matrices. This will also lead to changes in the codebooks used to exchange information.

In each of the various PLSSP embodiments, the methods described may be repeated a number of times to exchange as much information as needed, for example, to help establish a shared secret between Alice and Bob. In these further exchanges, Alice may be the one receiving a matrix G from Bob, and then sending back a matrix R to Bob that Bob decodes to determine shared bits. This leads to a bi-directional generation of shared bits between Alice and Bob.

The codebook matrices C and the transmission signal b, may be publicly known and publicly accessible.

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium.

Such networks can include, but are not limited to, any local area network (LAN), virtual LAN (VLAN), wide area network (WAN) (e.g., the Internet), software defined WAN (SD-WAN), wireless local area (WLA) access network, wireless wide area (WWA) access network, metropolitan area network (MAN), Intranet, Extranet, virtual private network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/6G/nG, IEEE 802.11 (e.g., Wi-Fi®/Wi-Fi6®), IEEE 802.16 (e.g., Worldwide Interoperability for Microwave Access (WiMAX)), Radio-Frequency Identification (RFID), Near Field Communication (NFC), Bluetooth™, mm wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may be directly or indirectly connected utilizing any algorithms, communication protocols, interfaces, etc. (proprietary and/or non-proprietary) that allow for the exchange of data and/or information.

Communications in a network environment can be referred to herein as ‘messages’, ‘messaging’, ‘signaling’, ‘data’, ‘content’, ‘objects’, ‘requests’, ‘queries’, ‘responses’, ‘replies’, etc. which may be inclusive of packets. As referred to herein and in the claims, the term ‘packet’ may be used in a generic sense to include packets, frames, segments, datagrams, and/or any other generic units that may be used to transmit communications in a network environment. Generally, a packet is a formatted unit of data that can contain control or routing information (e.g., source and destination address, source and destination port, etc.) and data, which is also sometimes referred to as a ‘payload’, ‘data payload’, and variations thereof. In some embodiments, control or routing information, management information, or the like can be included in packet fields, such as within header(s) and/or trailer(s) of packets. Internet Protocol (IP) addresses discussed herein and in the claims, can include any IP version 4 (IPv4) and/or IP version 6 (IPv6) addresses.

As used herein, a ‘transmitter’ (or ‘signal transmitter’) refers to any collection of components that are used in the transmission of signals, including any combination of, but not limited to, one or more: antennas, amplifiers, cables, digital-to-analog converters, analog-to-digital converters, filters, up-converters, encoders, modulators, multiplexers, processors (e.g., for reading bits and/or mapping of bits to a baseband), control circuitry, oscillators, etc. Similarly, as used herein, a ‘receiver’ (or ‘signal receiver’) refers to any collection of components that are used in receiving signals, including any combination of, but not limited to, one or more: antennas, amplifiers, cables, analog-to-digital converters, digital-to-analog converters, filters, down-converters, decoders, demodulators, demultiplexers, processors, detectors, control circuitry, oscillators, etc. Further the transmitter and receiver may be implemented using analog components, digital components, or a mix of analog and digital components. Further the transmitter and receiver may use analog signals, digital signals, or a mix of analog and digital signals.

To the extent that embodiments presented herein relate to the storage of data, the embodiments may employ any number of any conventional or other databases, data stores or storage structures (e.g., files, databases, data structures, data or other repositories, etc.) to store information.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments. Note also that a module, engine, client, controller, function, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of’, ‘one or more of’, ‘and/or’, variations thereof, or the like are open-ended expressions that are both conjunctive and disjunctive in operation for any and all possible combination of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of’ and ‘one or more of’ can be represented using the ‘(s)’ nomenclature (e.g., one or more element(s)).

In summary, the techniques presented herein implement various embodiments of a PLSSP.

In some aspects, the techniques described herein relate to a method including: receiving at a first processor of a first communication device, a first encoded matrix based upon a unitary matrix distorted by an effective communication channel; determining a unitary projection of the first encoded matrix; selecting a codebook matrix from a codebook of unitary matrices, the codebook matrix associated with a message for transmission; multiplying the conjugate of the unitary projection of the first encoded matrix by the codebook matrix to produce a second encoded matrix; and transmitting a signal representing the second encoded matrix to a second communication device.

In some aspects, the techniques described herein relate to a method, wherein determining the unitary projection of the first encoded matrix includes determining a right singular matrix and a left singular matrix from a singular value decomposition of the first encoded matrix.

In some aspects, the techniques described herein relate to a method, wherein multiplying the unitary projection of the first encoded matrix by the codebook matrix includes: multiplying a transpose of the right singular matrix by the codebook matrix to produce an intermediate matrix; and multiplying a complex conjugate of the left singular matrix by the intermediate matrix to produce the second encoded matrix.

In some aspects, the techniques described herein relate to a method, wherein the first communication device and the second communication device include a plurality of antennas, the first communication device and the second communication device configured to perform Multiple Input Multiple Output (MIMO) operations.

In some aspects, the techniques described herein relate to a method, wherein the codebook of unitary matrices is publicly accessible.

In some aspects, the techniques described herein relate to a method, further including transmitting signals representing a plurality of additional encoded matrices to the second communication device until a predetermined number of messages have been sent.

In some aspects, the techniques described herein relate to a method, wherein each codebook matrix from the codebook of unitary matrices corresponds to one or more bits based on an index of each respective codebook matrix in the codebook of unitary matrices.

In some aspects, the techniques described herein relate to a method, wherein the unitary matrix is a diagonal unitary matrix.

In some aspects, the techniques described herein relate to a method, wherein the unitary matrix is a scalar multiple of an identity matrix.

In some aspects, the techniques described herein relate to a method, including: sending a first unitary matrix from a first communication device to a second communication device via a forward communication channel; receiving from the second communication device, at a first processor of the first communication device, a first encoded matrix distorted by a reverse communication channel, wherein the first encoded matrix is based upon the first unitary matrix distorted by the forward communication channel and a codebook matrix selected from a codebook of unitary matrices; determining a unitary projection of the first encoded matrix; multiplying a transpose of the first unitary matrix by the unitary projection of the first encoded matrix to produce a recovered matrix; and determining which codebook matrix from the codebook of unitary matrices corresponds to the recovered matrix.

In some aspects, the techniques described herein relate to a method, wherein determining the unitary projection of the first encoded matrix includes determining a right singular matrix and a left singular matrix from a singular value decomposition of the first encoded matrix.

In some aspects, the techniques described herein relate to a method, wherein multiplying the transpose of the first unitary matrix by the unitary projection of the first encoded matrix includes: multiplying a transpose of the first unitary matrix by the left singular matrix to produce an intermediate matrix; and multiplying the intermediate matrix by a conjugate transpose of the right singular matrix to produce the recovered matrix.

In some aspects, the techniques described herein relate to a method, wherein the first communication device and the second communication device include a plurality of antennas, the first communication device and the second communication device configured to perform Multiple Input Multiple Output (MIMO) operations.

In some aspects, the techniques described herein relate to a method, wherein the codebook of unitary matrices is publicly accessible.

In some aspects, the techniques described herein relate to a method, further including transmitting signals representing a plurality of additional encoded matrices to the first communication device until a predetermined number of messages have been sent.

In some aspects, the techniques described herein relate to a method, wherein each codebook matrix from the codebook of unitary matrices corresponds to one or more bits based on an index of each respective codebook matrix in the codebook of unitary matrices.

In some aspects, the techniques described herein relate to a method, wherein determining which codebook matrix from the codebook of unitary matrices corresponds to the recovered matrix further includes: calculating a Frobenius distance between the recovered matrix and each codebook matrix from the codebook of unitary matrices; and selecting the codebook matrix from the codebook of unitary matrices having a shortest Frobenius distance from the recovered matrix as a corresponding codebook matrix.

In some aspects, the techniques described herein relate to a method, wherein determining which codebook matrix from the codebook of unitary matrices corresponds to the recovered matrix further includes: calculating a diversity distance between the recovered matrix and each codebook matrix from the codebook of unitary matrices; and selecting the codebook matrix from the codebook of unitary matrices having a shortest diversity distance from the recovered matrix as a corresponding codebook matrix.

In some aspects, the techniques described herein relate to a method, wherein determining which codebook matrix from the codebook of unitary matrices corresponds to the recovered matrix further includes: calculating a metric as a sum of real components of diagonal elements of a main diagonal of the recovered matrix; and selecting the codebook matrix from the codebook of unitary based upon a sign of the metric.

In some aspects, the techniques described herein relate to a method, wherein determining which codebook matrix from the codebook of unitary matrices corresponds to the recovered matrix further includes: calculating a first metric as a sum of real components of diagonal elements along a main diagonal of the recovered matrix; calculating a second metric as a difference of real components of diagonal elements along an anti-diagonal of the recovered matrix; and selecting the codebook matrix from the codebook of unitary based upon whether the first metric and the second metric is larger and a sign of a largest of the first metric and the second metric.

In some aspects, the techniques described herein relate to a method, wherein determining which codebook matrix from the codebook of unitary matrices corresponds to the recovered matrix further includes: calculating a first metric as a sum of real components of diagonal elements along a main diagonal of the recovered matrix; calculating a second metric as a difference of real components of diagonal elements along a main diagonal of the recovered matrix; calculating a third metric as a sum of real components of diagonal elements along an anti-diagonal of the recovered matrix; calculating a fourth metric as the difference of real components of diagonal elements along an anti-diagonal of the recovered matrix; and selecting the codebook matrix from the codebook of unitary based upon a largest of the first metric, second metric, third metric, and the fourth metric and a sign of a largest of the first metric, second metric, third metric, and the fourth metric.

In some aspects, the techniques described herein relate to a method, wherein the first unitary matrix is a diagonal unitary matrix.

In some aspects, the techniques described herein relate to a method, wherein: codebook matrices in the codebook of unitary matrices differ by global phase in multiples of a form e^{iθ} where θ is an angle, and determining which codebook matrix from the codebook of unitary matrices corresponds to the recovered matrix further includes determining a closest multiple of e^{iθ} I to the recovered matrix.

In some aspects, the techniques described herein relate to a method, wherein the first unitary matrix is a scalar multiple of an identity matrix.

In some aspects, the techniques described herein relate to a method including: receiving a first encoded matrix via at least two antennas of a first communication device, wherein each row of the first encoded matrix corresponds to a first encoded vector transmitted from a single antenna of a second communication device and received by a corresponding antenna of the at least two antennas of the first communication device; determining a left singular matrix of the first encoded matrix and a right singular matrix of the first encoded matrix; selecting a codebook matrix, from a codebook of unitary matrices, for a message for transmission; multiplying the codebook matrix by a conjugate transpose of the right singular matrix of the first encoded matrix to produce an intermediate matrix; multiplying a complex conjugate of the left singular matrix of the first encoded matrix by the intermediate matrix to produce a second encoded matrix; and transmitting a signal representing the second encoded matrix to the single antenna of the second communication device.

In some aspects, the techniques described herein relate to a method, wherein the codebook of unitary matrices is publicly accessible.

In some aspects, the techniques described herein relate to a method, further including transmitting signals representing a plurality of additional encoded matrices to the second communication device until a predetermined number of messages have been sent.

In some aspects, the techniques described herein relate to a method, wherein each codebook matrix from the codebook of unitary matrices corresponds to one or more bits based on an index of each respective codebook matrix in the codebook of unitary matrices.

In some aspects, the techniques described herein relate to a method, including: sending a first encoded vector based on a first unitary matrix from a single antenna of a first communication device to at least two antennas of a second communication device; receiving, via the single antenna of the first communication device, a second encoded vector transmitted from the at least two antennas of the second communication device, wherein the second encoded vector is based upon the first unitary matrix, a codebook matrix selected from a codebook of unitary matrices, and a representation of an effective channel; expanding the second encoded vector into a second encoded matrix; determining a left singular matrix of the second encoded matrix and a right singular matrix of the second encoded matrix; multiplying a conjugate transpose of the first unitary matrix by a complex conjugate of the left singular matrix of the second encoded matrix to produce an intermediate matrix; multiplying a conjugate transpose of the right singular matrix of the second encoded matrix by the intermediate matrix to produce a recovered matrix; and determining which codebook matrix from the codebook of unitary matrices corresponds to the recovered matrix.

In some aspects, the techniques described herein relate to a method, wherein the codebook of unitary matrices is publicly accessible.

In some aspects, the techniques described herein relate to a method, further including transmitting signals representing a plurality of additional encoded matrices to the second communication device until a predetermined number of messages have been sent.

In some aspects, the techniques described herein relate to a method, wherein each codebook matrix from the codebook of unitary matrices corresponds to one or more bits based on an index of each respective codebook matrix in the codebook of unitary matrices.

In some aspects, the techniques described herein relate to a method, wherein: each codebook matrix in the codebook of unitary matrices is based upon a unique angle value, and determining which codebook matrix from the codebook of unitary matrices corresponds to the recovered codebook matrix further includes: calculating an arccosine function of a magnitude of a first element of a first row of the recovered codebook matrix to produce a first metric; and selecting the codebook matrix from the codebook of unitary matrices having an associated angle value closest to the first metric.

In some aspects, the techniques described herein relate to a method including: receiving a first encoded vector via a single antenna of a first communication device, wherein the first encoded vector is based upon a unitary matrix transmitted by at least two antennas of a second communication device and distorted by an effective channel; expanding the first encoded vector into a first encoded matrix; determining a left singular matrix of the first encoded matrix and a right singular matrix of the first encoded matrix; selecting, via the first processor, a codebook matrix, from a codebook of unitary matrices, for a message for transmission; multiplying the codebook matrix by a conjugate transpose of the right singular matrix of the first encoded matrix to produce an intermediate matrix; multiplying a complex conjugate of the left singular matrix of the first encoded matrix by the intermediate matrix to produce a second encoded matrix; and transmitting a signal representing the second encoded matrix to at least two antennas of a second communication device.

In some aspects, the techniques described herein relate to a method, wherein the codebook of unitary matrices is publicly accessible.

In some aspects, the techniques described herein relate to a method, further including transmitting signals representing a plurality of additional encoded matrices to the first communication device until a predetermined number of messages have been sent.

In some aspects, the techniques described herein relate to a method, wherein each codebook matrix from the codebook of unitary matrices corresponds to one or more bits based on an index of each respective codebook matrix in the codebook of unitary matrices.

In some aspects, the techniques described herein relate to a method, including: sending a first encoded matrix via at least two antennas of a first communication device to a single antenna of a second communication device, the first encoded matrix based on a first unitary matrix; receiving a second encoded matrix via the at least two antennas of the first communication device, wherein each row of the second encoded matrix corresponds to an encoded vector transmitted from the single antenna of the second communication device and received by a corresponding antenna of the at least two antennas of the first communication device, wherein the encoded vector is based upon the first unitary matrix distorted by an effective channel and a codebook matrix selected from a codebook of unitary matrices; determining a left singular matrix of the second encoded matrix and a right singular matrix of the second encoded matrix; multiplying a conjugate transpose of the first unitary matrix by a complex conjugate of the left singular matrix of the second encoded matrix to produce an intermediate matrix; multiplying a conjugate transpose of the right singular matrix of the second encoded matrix by the intermediate matrix to produce a recovered matrix; and determining which codebook matrix from the codebook of unitary matrices corresponds to the recovered matrix.

In some aspects, the techniques described herein relate to a method, wherein the codebook of unitary matrices is publicly accessible.

In some aspects, the techniques described herein relate to a method, further including transmitting signals representing a plurality of additional encoded matrices to the first communication device until a predetermined number of messages have been sent.

In some aspects, the techniques described herein relate to a method, wherein each codebook matrix from the codebook of unitary matrices corresponds to one or more bits based on an index of each respective codebook matrix in the codebook of unitary matrices.

In some aspects, the techniques described herein relate to a method, wherein: each codebook matrix in the codebook of unitary matrices is based upon a unique angle value, and determining which codebook matrix from the codebook of unitary matrices corresponds to the recovered matrix further includes: calculating an arccosine function of a magnitude of a first element of a first row of the codebook matrix to produce a first metric; and selecting the codebook matrix from the codebook of unitary matrices having an associated angle value closest to the first metric.

In some aspects, the techniques described herein relate to a method, including: sending a first unitary matrix from a first communication device to a second communication device over a forward wireless channel; receiving, via a reverse wireless channel, a first encoded matrix from the second communication device, wherein the first encoded matrix is based upon the first unitary matrix distorted by the forward wireless channel and a codebook matrix selected from a codebook of unitary matrices; determining a left singular matrix of the first encoded matrix and a right singular matrix of the first encoded matrix; multiplying a conjugate transpose of the first unitary matrix by a complex conjugate of the left singular matrix of the first encoded matrix to produce an intermediate matrix; multiplying a conjugate transpose of the right singular matrix of the first encoded matrix by the intermediate matrix to produce a recovered matrix; calculating at least one metric using elements of the recovered matrix; and selecting a codebook matrix from the codebook of unitary matrices based upon the at least one metric to determine which codebook matrix from the codebook of unitary matrices corresponds to the recovered matrix.

In some aspects, the techniques described herein relate to a method, wherein the first communication device and the second communication device include a plurality of antennas, the first communication device and the second communication device configured to perform Multiple Input Multiple Output (MIMO) operations.

In some aspects, the techniques described herein relate to a method, wherein the codebook of unitary matrices is publicly accessible.

In some aspects, the techniques described herein relate to a method, further including receiving a plurality of additional encoded matrices from the second communication device until a predetermined number of messages have been received.

In some aspects, the techniques described herein relate to a method, wherein each codebook matrix from the codebook of unitary matrices corresponds to one or more bits based on an index of each respective codebook matrix in the codebook of unitary matrices.

In some aspects, the techniques described herein relate to a method, wherein calculating the at least one metric using elements of the recovered matrix includes subtracting an absolute value of a second element of a first row of the recovered matrix from an absolute value of a first element of a first row of the recovered matrix.

In some aspects, the techniques described herein relate to a method, wherein calculating the at least one metric using elements of the recovered matrix includes calculating a real portion of a product of a second element of a first row of the recovered matrix and a complex conjugate of a first element of a second row of the recovered matrix.

In some aspects, the techniques described herein relate to a method, wherein calculating the at least one metric includes: calculating a first metric using elements of the recovered matrix; calculating a second metric using elements of the recovered matrix; and selecting a codebook matrix from the codebook of unitary matrices based upon which of a set of first metric threshold values that is closest to the first metric and upon which of a set of second metric threshold values that is closest to the second metric.

In some aspects, the techniques described herein relate to a method, wherein calculating the first metric using elements of the recovered matrix includes calculating:

$${s}_{1} = arg ( \vert {\hat{c}}_{11} \vert + \vert {\hat{c}}_{12} \vert i )$$

where s₁ is the first metric and ĉ₁₁ and ĉ₁₂ are elements of the recovered matrix.

In some aspects, the techniques described herein relate to a method, wherein calculating the second metric using elements of the recovered matrix includes calculating:

$${s}_{2} = arg ( - \frac{{\hat{c}}_{12}}{{\hat{c}}_{21}} )$$

where s₂ is the second metric and ĉ₁₂ and ĉ₂₁ are elements of the recovered matrix.

In further aspects, the techniques described herein relate to systems configured to perform one or more of the methods described herein. The systems may be configured with instructions stored in computer readable storage media that configures one or more processing elements and/or modules to perform one or more of the methods described herein. The systems may include additional analog or digital elements to enable processing elements to perform one or more of the methods described herein.

Each example embodiment disclosed herein has been included to present one or more different features. However, all disclosed example embodiments are designed to work together as part of a single larger system or method. The disclosure explicitly envisions compound embodiments that combine multiple previously-discussed features in different example embodiments into a single system or method.

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

What is claimed is:

1. A method, comprising:
sending a first encoded vector based on a first unitary matrix from a single antenna of a first communication device to at least two antennas of a second communication device;
receiving, via the single antenna of the first communication device, a second encoded vector transmitted from the at least two antennas of the second communication device, wherein the second encoded vector is based upon the first unitary matrix, a codebook matrix selected from a codebook of unitary matrices, and a representation of an effective channel;
expanding the second encoded vector into a second encoded matrix;
determining a left singular matrix of the second encoded matrix and a right singular matrix of the second encoded matrix;
multiplying a conjugate transpose of the first unitary matrix by a complex conjugate of the left singular matrix of the second encoded matrix to produce an intermediate matrix;
multiplying a conjugate transpose of the right singular matrix of the second encoded matrix by the intermediate matrix to produce a recovered matrix; and
determining which codebook matrix from the codebook of unitary matrices corresponds to the recovered matrix.

2. The method of claim 1, wherein the codebook of unitary matrices is publicly accessible.

3. The method of claim 1, further comprising transmitting signals representing a plurality of additional encoded matrices to the second communication device until a predetermined number of messages have been sent.

4. The method of claim 1, wherein each codebook matrix from the codebook of unitary matrices corresponds to one or more bits based on an index of each respective codebook matrix in the codebook of unitary matrices.

5. The method of claim 1, wherein:
each codebook matrix in the codebook of unitary matrices is based upon a unique angle value, and
determining which codebook matrix from the codebook of unitary matrices corresponds to the recovered matrix further includes:
calculating an arccosine function of a magnitude of a first element of a first row of the recovered matrix to produce a first metric; and
selecting the codebook matrix from the codebook of unitary matrices having an associated angle value closest to the first metric.

6. An apparatus comprising:
a single antenna configured to transmit and receive wireless signals; and
a processor configured to:
cause the single antenna to send a first encoded vector based on a first unitary matrix to at least two antennas of a remote communication device;
receiving, via the single antenna, a second encoded vector transmitted from the at least two antennas of the remote communication device, wherein the second encoded vector is based upon the first unitary matrix, a codebook matrix selected from a codebook of unitary matrices, and a representation of an effective channel;
expanding the second encoded vector into a second encoded matrix;
determining a left singular matrix of the second encoded matrix and a right singular matrix of the second encoded matrix;
multiplying a conjugate transpose of the first unitary matrix by a complex conjugate of the left singular matrix of the second encoded matrix to produce an intermediate matrix;
multiplying a conjugate transpose of the right singular matrix of the second encoded matrix by the intermediate matrix to produce a recovered matrix; and
determining which codebook matrix from the codebook of unitary matrices corresponds to the recovered matrix.

7. The apparatus of claim 6, wherein the codebook of unitary matrices is publicly accessible.

8. The apparatus of claim 6, wherein the processor is further configured to cause the single antenna to transmit signals representing a plurality of additional encoded matrices to the remote communication device until a predetermined number of messages have been sent.

9. The apparatus of claim 6, wherein each codebook matrix from the codebook of unitary matrices corresponds to one or more bits based on an index of each respective codebook matrix in the codebook of unitary matrices.

10. The apparatus of claim 6, wherein each codebook matrix in the codebook of unitary matrices is based upon a unique angle value, and
wherein the processor is further configured to determine which codebook matrix from the codebook of unitary matrices corresponds to the recovered matrix by:
calculating an arccosine function of a magnitude of a first element of a first row of the recovered matrix to produce a first metric; and
selecting the codebook matrix from the codebook of unitary matrices having an associated angle value closest to the first metric.

11. A method, comprising:
sending a first encoded matrix via at least two antennas of a first communication device to a single antenna of a second communication device, the first encoded matrix based on a first unitary matrix;
receiving a second encoded matrix via the at least two antennas of the first communication device, wherein each row of the second encoded matrix corresponds to an encoded vector transmitted from the single antenna of the second communication device and received by a corresponding antenna of the at least two antennas of the first communication device, wherein the encoded vector is based upon the first unitary matrix distorted by an effective channel and a codebook matrix selected from a codebook of unitary matrices;
determining a left singular matrix of the second encoded matrix and a right singular matrix of the second encoded matrix;
multiplying a conjugate transpose of the first unitary matrix by a complex conjugate of the left singular matrix of the second encoded matrix to produce an intermediate matrix;
multiplying a conjugate transpose of the right singular matrix of the second encoded matrix by the intermediate matrix to produce a recovered matrix; and
determining which codebook matrix from the codebook of unitary matrices corresponds to the recovered matrix.

12. The method of claim 11, wherein the codebook of unitary matrices is publicly accessible.

13. The method of claim 11, further comprising transmitting signals representing a plurality of additional encoded matrices to the first communication device until a predetermined number of messages have been sent.

14. The method of claim 11, wherein each codebook matrix from the codebook of unitary matrices corresponds to one or more bits based on an index of each respective codebook matrix in the codebook of unitary matrices.

15. The method of claim 11, wherein:
each codebook matrix in the codebook of unitary matrices is based upon a unique angle value, and
determining which codebook matrix from the codebook of unitary matrices corresponds to the recovered matrix further includes:
calculating an arccosine function of a magnitude of a first element of a first row of the codebook matrix to produce a first metric; and
selecting the codebook matrix from the codebook of unitary matrices having an associated angle value closest to the first metric.
